(19) United States
(12) Patent Application Publication
(10) Pub. No.: US 2014/0337749 A1
(43) Pub. Date: Nov. 13, 2014

(54) DISPLAY APPARATUS AND GRAPHIC USER INTERFACE SCREEN PROVIDING METHOD THEREOF

(71) Applicant: SAMSUNG ELECTRONICS CO., LTD., Suwon-si (KR)

(72) Inventors: Joon-ho PHANG, Seoul (KR); Joo-sun MOON, Seoul (KR); Do-sung JUNG, Seoul (KR); Hong-pyo KIM, Goyang-si (KR); Yi-sak PARK, Seoul (KR); Christopher E. BANGLE, Clavesana CN (IT)

(73) Assignee: SAMSUNG ELECTRONICS CO., LTD., Suwon-si (KR)

(21) Appl. No.: 14/275,418

(22) Filed: May 12, 2014

(30) Foreign Application Priority Data
May 10, 2013 (KR) 10-2013-0053446

(51) Int. Cl. G06F 3/0481; G06F 3/0482; G06F 3/01

(52) U.S. Cl. CPC G06F 3/04815; G06F 3/012; G06F 3/0482
USPC 715/740; 715/781

(57) ABSTRACT

A display apparatus includes a display configured to display a GUI screen including a plurality of regions, a user interface configured to receive a user interaction with respect to the GUI screen, and a controller configured to control the display to display a region corresponding to the user interaction among the plurality of regions as a main region by rotating the GUI screen, and configured to perform a control operation mapped to the main region, wherein the main region is a region that occupies the GUI screen at a predetermined ratio or more.

### CROSS-REFERENCE TO RELATED APPLICATION

This application claims priority from Korean Patent Application No. 10-2013-0053446, filed on May 10, 2013, in the Korean Intellectual Property Office, the disclosure of which is incorporated herein by reference in its entirety.

### BACKGROUND

1. Field

Apparatuses and methods consistent with exemplary embodiments relate to a display apparatus and a graphic user interface (GUI) screen providing method thereof, and more particularly, to a display apparatus which provides a GUI screen according to a view point of a user, and a GUI screen providing method thereof.

2. Description of the Related Art

With the development of electronic technology, various types of display apparatuses have been developed. In particular, display apparatuses such as televisions (TVs), personal computers (PCs), tablet PCs, portable phones, and MPEG audio layer-3 (MP3) players have been widely distributed.

To meet needs of users who want newer and various functions, new types of display apparatuses are recently developed. For example, in the recently developed display apparatuses, various types of interfaces configured to control the display apparatuses are provided.

In this regard, there is a need for a method for providing an interface screen which may intuitively provide a variety of information and improve user convenience in operating the interface screen.

### SUMMARY

Exemplary embodiments may address at least the above problems and/or disadvantages and other disadvantages not described above. Also, exemplary embodiments are not required to overcome the disadvantages described above, and an exemplary embodiment may not overcome any of the problems described above.

One or more exemplary embodiments provide a display apparatus which displays a region corresponding to a view point of a user among a plurality of regions, and provides a service corresponding to the region, and a graphic user interface (GUI) screen providing method thereof.

According to an aspect of an exemplary embodiment, a display apparatus includes a display configured to display a graphic user interface (GUI) screen including a plurality of regions, a user interface configured to receive a user interaction with respect to the GUI screen, and a controller configured to control the display to display a region corresponding to the user interaction among the plurality of regions as a main region according to a changed user's perspective, and configured to perform a control operation mapped to the main region.

A plurality of control operations of providing at least one from among information, services, and functions are mapped to the plurality of regions, respectively.

The plurality of regions may include a ceiling region located on an upper portion of the GUI screen, a wall region located on an intermediate portion of the GUI screen, and a floor region located on a bottom portion of the GUI screen.

The controller may provide an information service when the ceiling region is displayed as the main region.

The information service may include a weather information providing service.

The controller may provide a commerce service when the wall region is displayed as the main region.

The commerce service may be a service for providing virtual purchase of a product in connection with real purchase of the product.

The controller may provide a control service when the floor region is displayed as the main region.

The control service may include at least one from among a home device control service and a home security control service.

The user interface may receive the user interaction according to a head direction of a user, and the controller may control to display the ceiling region as the main region when a user interaction according to an upward head direction of the user is received, and to display the floor region as the main region when a user interaction according to a downward head direction of the user is received, in a state in which the wall region is displayed as the main region.

The user interface may receive a remote controller signal according to a motion of a remote control apparatus configured to remotely control the display apparatus, and the controller may control to display the ceiling region as the main region when a remote controller signal corresponding to a motion in which the remote control apparatus is moved upward is received, and to display the floor region as the main region when a remote controller signal corresponding to a motion in which the remote control apparatus is moved downward is received, in a state in which the wall region is displayed as the main region.

The controller may control to display a background element based on at least one from among external environment information and a type of content corresponding to the control operation mapped to the main region.

The main region may be a region that occupies the GUI screen at a predetermined ratio or more.

According to an aspect of another exemplary embodiment, a method of providing a graphic user interface (GUI) screen of a display apparatus configured to provide a GUI screen including a plurality of regions includes receiving a user interaction with respect to the GUI screen, and displaying a region corresponding to the user interaction among the plurality of regions as a main region according to a changed user's perspective and performing a control operation mapped to the main region.

A plurality of control operations of providing at least one from among information, services, and functions are mapped to the plurality of regions, respectively.

The plurality of regions may include a ceiling region located on an upper portion of the GUI screen, a wall region located on an intermediate portion of the GUI screen, and a floor region located on a bottom portion of the GUI screen.

The performing may include providing an information service when the ceiling region is displayed as the main region.

The performing may include providing a commerce service when the wall region is displayed as the main region.

The performing may include providing a control service when the floor region is displayed as the main region.

The control service may include at least one from among a home device control service and a home security control service.

The displaying may include displaying the ceiling region as the main region when a user interaction according to an upward head movement is received, and displaying the floor region as the main region when a user interaction according to a downward head movement is received, in a state in which the wall region is displayed as the main region.

According to an aspect of still another exemplary embodiment, a display apparatus includes a display configured to display a graphic user interface (GUI) screen comprising a three dimension (3D) space, the 3D space comprising a plurality of plane images; a user interface configured to receive a user input for selecting at least one of plane images of the GUI screen; and a controller configured to perform a control operation corresponding to the selected at least one of the plurality of plane images.

According to an aspect of still another exemplary embodiment, a user interface processing device includes at least one processor operable to read and operate according to instructions within a computer program; and at least one memory operable to store at least portions of said computer program for access by said processor; wherein said computer program includes algorithms to cause said processor to implement: a user interface configured to receive a user input indicating a viewpoint of a user with respect to a graphic user interface (GUI) screen comprising a three dimension (3D) space; and a controller configured to perform a control operation corresponding to the GUI screen adjusted according to the viewpoint of the user based on the user input, the control operation being selected from a plurality of control operations mapped to objects displayed in the adjusted GUI screen.

According to an aspect of still another exemplary embodiment, provided is a non-transitory computer readable storing medium that stores a program for enabling a computer to perform the above method.

### BRIEF DESCRIPTION OF THE DRAWINGS

The above and/or other aspects will be more apparent by describing certain exemplary embodiments with reference to the accompanying drawings, in which:

FIG. 1 is a view explaining a display system according to an exemplary embodiment;

FIG. 2(a) and (b) are block diagrams illustrating configurations of display apparatuses according to an exemplary embodiment;

FIG. 3 is a view explaining various software modules stored in a storage according to an exemplary embodiment;

FIGS. 4A to 5B are views illustrating user interface (UI) screens according to an exemplary embodiments;

FIGS. 6A to 6B are views illustrating UI screens according to another exemplary embodiments;

FIGS. 7A to 7C are views illustrating UI screens provided in a ceiling space according to various exemplary embodiments;

FIGS. 8A to 8C are views illustrating UI screens provided in a floor space according to various exemplary embodiments;

FIGS. 9A to 9B are views illustrating UI screens provided in a wall space according to various exemplary embodiments;

FIGS. 10A to 11B are views illustrating background screens provided by a wall space according to various exemplary embodiments;

FIGS. 12A to 12C are views illustrating a function or information providable by a ceiling space according to various exemplary embodiments;

FIGS. 13A to 13C are views illustrating a function or information providable by a floor space according to various exemplary embodiments

FIG. 14 is a flowchart explaining a UI screen providing method according to an exemplary embodiment; and

FIG. 15 is a flowchart explaining a UI screen providing method according to another exemplary embodiment.

### DETAILED DESCRIPTION

Certain exemplary embodiments will now be described in greater detail with reference to the accompanying drawings.

In the following description, the same reference numerals are used for the same elements even in different drawings. The matters defined in the description, such as detailed construction and elements, are provided to assist in a comprehensive understanding of the disclosure. Thus, it is apparent that the exemplary embodiments can be carried out without those specifically defined matters. Also, well-known functions or constructions are not described in detail since they would obscure the disclosure with unnecessary detail.

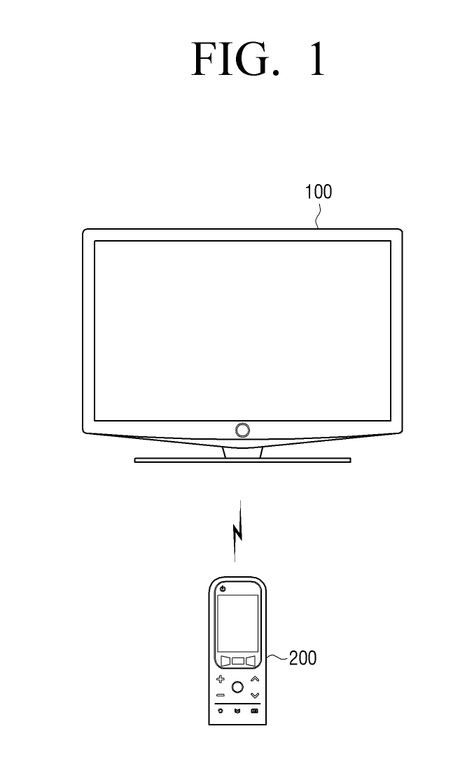

FIG. 1 is view explaining a display system according to an exemplary embodiment.

Referring to FIG. 1, the display system according to an exemplary embodiment includes a display apparatus 100 and a remote control apparatus 200.

The display apparatus 100 may be implemented as a digital television (TV) as illustrated in FIG. 1, but the display apparatus 100 is not limited thereto. The display apparatus may be implemented as various types of apparatuses having a display function, such as, for example, a personal computer (PC), a portable phone, a tablet PC, a portable multimedia player (PMP), a personal digital assistant (PDA), or a navigation system. When the display apparatus 100 is implemented as a portable apparatus, the display apparatus 100 may be implemented with a touch screen embedded therein to execute a program using a finger or a pen (for example, a stylus pen). Hereinafter, for convenience of description, it is assumed and described that the display apparatus 100 is implemented as the digital TV.

When the display apparatus 100 is implemented as the digital TV, the display apparatus 100 may be controlled by a user motion or the remote control apparatus 200. At this time, the remote control apparatus 200 is an apparatus configured to remotely control the display apparatus 100, and may receive a user command, and transmit a control signal corresponding to the input user command to the display apparatus 100. For example, the remote control apparatus 200 may be implemented in various types, for example, to sense a motion of the remote control apparatus 200 and transmit a signal corresponding to the motion, to recognize a voice and transmit a signal corresponding to the recognized voice, or to transmit a signal corresponding to an input key. At this time, the remote control apparatus 200 may include, for example, a motion sensor, a touch sensor, or an optical joystick (OJ) sensor to which optical technology is applied, a physical button (for example, a tact switch), a display screen, a microphone, and the like configured to receive various types of user commands. Here, the OJ sensor is an image sensor configured to sense a user operation through an OJ, and operates similar to an upside-down optical mouse. That is, the user simply needs to control the OJ with a finger for the OJ sensor to analyze a signal.

The display apparatus 100 may provide various three-dimensional (3D) user interface (UI) screen according to a user command input through the remote control apparatus 200.

In particular, the display apparatus 100 may provide a graphic user interface (GUI) screen including at least one polyhedral icon, and configured to correspond to a plurality of perspectives of the user. Hereinafter, various exemplary embodiments will be described with reference to block diagrams illustrating specific configurations of the display apparatus 100.

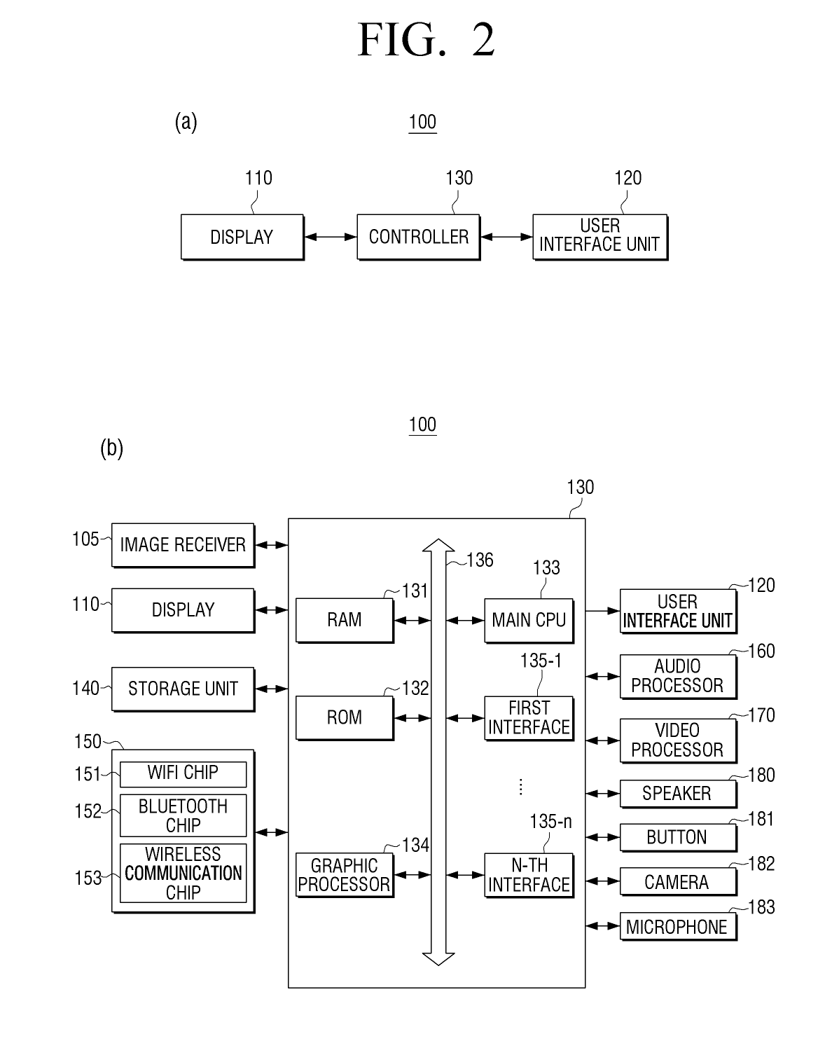

FIG. 2(a) and (b) are block diagrams illustrating configurations of a display apparatus according to an exemplary embodiment.

Referring to FIG. 2(a), a display apparatus 100 includes a display 110, a user interface 120, and a controller 130.

The display 110 displays a screen. Here, the screen may include a reproduction screen of a variety of content such as an image, a moving image, a text, and music, an application execution screen of an application including a variety of content, a web browser screen, or a GUI screen.

Here, the display 110 may be implemented as a liquid crystal display (LCD), an organic light emitting diode (OLED), and the like, but the display 110 is not limited thereto. In some embodiments, the display 110 may be implemented as a flexible display, a transparent display, and the like.

### <UI Including a Plurality of Space Elements>

The display 110 may display a GUI including a plurality of regions corresponding to a plurality of perspectives of a user.

Here, the GUI screen corresponding to the plurality of perspectives may include at least one of a GUI screen corresponding to a ceiling space, a GUI screen corresponding to a wall space, and a GUI screen corresponding to a floor space.

That is, the GUI screen may include a space like a room, i.e., the ceiling space, the wall space defined by three walls configured to support the ceiling space, and the floor space located below the three walls. One wall is a space in which the user is located, and a view point from which the user looks at a corresponding room in a location of a non-displayed space wall may be provided.

At this time, the UI screen providing a three dimensional (3D) space may be provided in a two dimension (2D) screen type or a 3D screen type. That is, the display 110 may implement a 3D screen by time-dividing a left-eye image and a right-eye image, and alternately displaying the time-divided left-eye image and right-eye image, and a sense of depth may be provided by a disparity between the left-eye image and the right-eye image. Therefore, the user may obtain depth information of various objects included in the UI screen, and feel a cubic (3D) effect. The 3D space in the 2D image may be provided through perspective processing for an object included in the UI screen.

### <Service (or Function) or Information Provided in Space Elements>

The GUI screen corresponding to a plurality of perspectives may provide at least one among information, functions, and service mapped with the plurality of perspectives. Specifically, in an exemplary embodiment, the ceiling space may provide an information service, the wall space may provide a commerce service, and the floor space may provide a control service. Here, the information service is a service for providing a variety of information, the commerce service is a service for providing an electronic commerce service through electronic media such as Internet, and the control service is a service for providing a function configured to control various apparatuses.

In another exemplary embodiment, the ceiling space may provide first type information, the wall space may provide second type information, and the floor space may provide third type information. For example, the respective types of information may include information for providing simple notification to the user, information for providing a mutual interaction with the user, and the like, but this is not limited thereto.

In another exemplary embodiment, the ceiling space may provide a first function, the wall space may provide a second function, and the floor space may provide a third function. For example, the first to the third functions may include a content reproducing function, a phone function, and the like, but this is not limited thereto.

The services, functions, and information may be provided in any combination thereof. That is, one space may provide the first type information, and other spaces may provide the second type information.

Different information or services may be provided to each user according to a user certification process. For example, the UI according to an exemplary embodiment may be implemented to provide a plurality of users with different UI screens through the certification of the user. That is, since even family members may have behavior patterns, preferences, and the like different from one another, a UI screen corresponding to a behavior pattern, a preference, a setting state of a corresponding user may be provided after the user certification process such as a login process is performed.

### <UI Background Element>

The UI screen according to an exemplary embodiment may include a background element.

Specifically, a background to which an environment element is reflected or a background corresponding to a content type may be displayed. In some embodiments, a background previously selected by the user may be displayed. Here, the environment element may include an external weather element such as rain, snow, thunder, fog, or wind, and a time element such as day and night. The content type may be determined by various elements such as a content genre, a content performer, and a content director.

For example, when it is currently raining, a background corresponding to a rainy weather may be provided. When content corresponding science fiction (SF) movie content is selected, a background including an unidentified flying object (UFO) image may be provided.

The background may provide various animation effects. For example, an animated image in which snow is falling, or in which an UFO raises an object may be provided. At this time, the content type-based background may be provided based on metadata information included in corresponding content. For example, a background element corresponding to a variety of metadata information may be pre-mapped and stored.

Further, the background element may be provided in a state in which the ceiling, the wall, and the floor spaces are maintained. Alternatively, the ceiling, the wall, and the floor spaces may disappear and only the background element may be displayed.

The background does not need to be displayed with other images, and the background element may be provided such that only color, brightness, and the like are adjusted.

<Cubic GUI Provided in a Wall Space>

The room space comprising three walls may provide a polyhedral GUI. Here, the polyhedron may be a cube, and at this time, the polyhedral GUI may be referred to as a cubic GUI. However, a polyhedron of the polyhedral GUI is not limited to a cubic shape. The polyhedron of the polyhedral GUI may be implemented in various shapes, such as a triangular prism, a hexagonal prism, or a rectangular parallelepiped. Hereinafter, it is assumed that the polyhedral GUI is a cubic GUI.

The cubic GUI displayed in the room space may be a regular hexagonal display element, and the cubic GUI may be implemented to represent a predetermined object. For example, the cubic GUI may represent various objects, such as content, a content provider, or a service provider.

At least one surface constituting the cubic GUI may function as an information surface configured to provide predetermined information to a user. The at least one surface constituting the cubic GUI may provide a variety of information according to the object represented by the cubic GUI. For example, the at least one surface constituting the cubic GUI may display a variety of information, such as content provider information, content information, service provider information, service information, application execution information, content execution information, and user information depending on a menu depth according to a user command. Further, the displayed information may include various elements such as a text, a file, an image, a moving image, an icon, a button, a menu, and a 3D icon. For example, the content provider information may be provided in a type of an icon, a logo, or the like which symbolizes a corresponding content provider, and the content information may be provided in a thumbnail form. The user information may be provided in a profile image of each user. The thumbnail may be provided by decoding additional information provided in original content, and converting the decoded additional information into a thumbnail size. Alternatively, when there is no additional information, the thumbnail may be provided by decoding the original content, converting the decoded original content in the thumbnail size, and extracting a reduced thumbnail image. Here, the original content may be a still image form or a moving image form. When the original content is a moving image, a thumbnail image may be generated in the form of an animated image comprising a plurality of still images.

### <Room Space Providing a Cubic GUI>

A cubic GUI may be displayed in a floating form in a room space.

Specifically, the display 110 may display the cubic GUI in a floating form in a three-dimensional (3D) space which is formed by three walls along an X-axis and a Y-axis of a screen and having a predetermined depth along a Z-axis. That is, the display 110 may display the UI screen in a form in which a plurality of cubic GUIs are floating in the room space in which a first wall of the three walls forms a left surface, a second wall forms a rear surface, and a third wall forms a right surface.

The plurality of cubic GUIs may be displayed to have a constant distance therebetween, and to be arranged in an n×m matrix form. However, the arrangement of the plurality of cubic GUIs is merely exemplary, and the plurality of cubic GUIs may have various types of arrangements such as a radial arrangement or a linear arrangement. The cubic GUIs may be provided in a 2D or 3D manner. Here, the 2D method may be a display method for displaying the cubic GUIs in a form in which only one surface of each of the cubic GUIs is displayed and the other surfaces thereof are hidden. The 3D method may be a method for displaying the cubic GUIs in a 3D form in which at least two surfaces of each of the cubic GUIs are displayed

Cubic GUIs which are to be displayed next may be displayed with a preset transparency in at least one of the three walls. Specifically, when cubic GUIs in a first cubic GUI list included in a corresponding cubic room included in a specific category are displayed, cubic GUIs included in a second cubic GUI list to be displayed next may be displayed with a preset transparency (for example, translucence) in, for example, the right wall. That is, the cubic GUIs which are to be displayed next on a wall constituting the cubic room may be provided in a preview format. At this time, cubic GUIs included in a cubic GUI list, which is disposed in a corresponding direction, may be translucently displayed on, for example, the left wall. For example, when there are first to fifth cubic GUI lists included in a cubic room, cubic GUIs included in a fifth cubic GUI list may be translucently displayed on the left wall. At this time, another cubic list may be displayed on a wall according to a user interaction with the wall. For example, when there is a preset interaction in a state in which the left wall is selected, a third cubic GUI list may be displayed on the left wall.

The ceiling space may be displayed to be above the three walls, and the floor space may be displayed to be below the three walls. However, the ceiling space and the floor space may be partially displayed while the room space comprising the three walls is displayed as a main space. Here, the main space may be a space positioned at a predetermined location of the GUI screen. In another example, the main space may be a space which occupies the GUI screen at a preset ratio or more.

### <Stellar Structure Comprising a Plurality of Room Spaces>

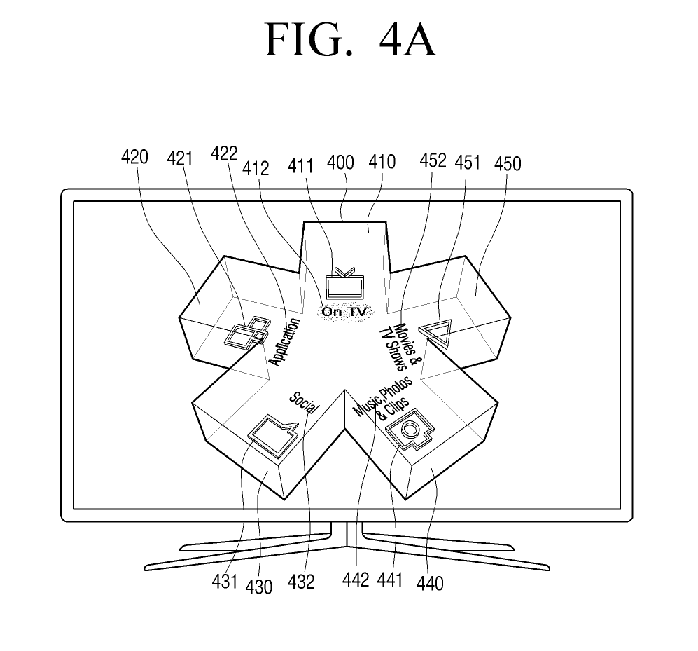

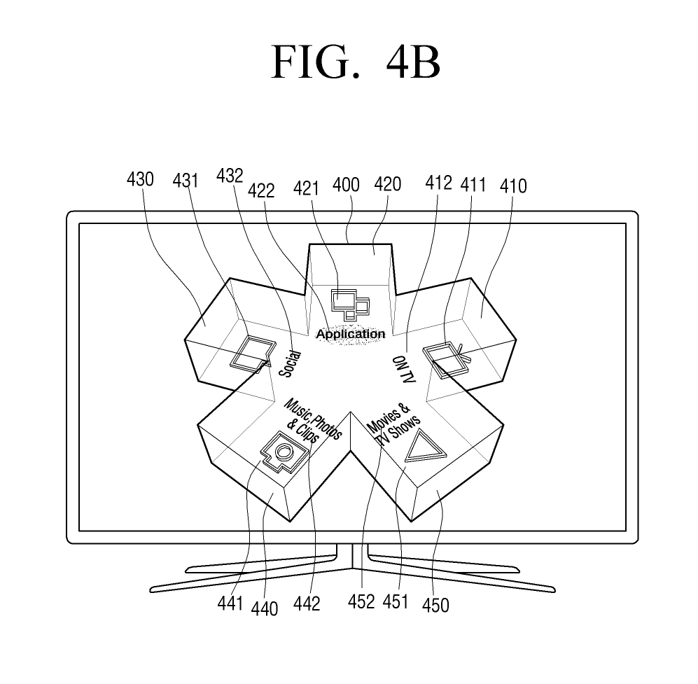

The 3D space including the cubic GUI may be implemented such that a plurality of 3D spaces are provided, and a new 3D space is displayed according to a rotation thereof. Specifically, an aisle area may be disposed in a center portion, and regular hexahedral 3D spaces may be disposed to be connected to each other through the aisle area. That is, an overall shape of the cubic rooms may be implemented to have a star-like structure (hereinafter, referred to as a stellar structure), as shown in FIGS. 4A and 4B. The 3D spaces may represent different categories, and an object included in each of the categories may be displayed through a cubic GUI. Here, the categories may be divided into various types, for example, a real time TV category, a video on demand (VOD) content-based category, a social networking service (SNS) content-based category, an application providing category, a personal content category, and the like. The division of the categories is merely exemplary, and the categories may be divided according to various criteria. At this time, existing ceiling, wall, and floor constituting the 3D space may be replaced with new ceiling, wall, and floor according to a rotation of the 3D space.

In addition, specific examples of a service or information provided in space elements will be described later with reference to the accompanying drawings.

The user interface 120 may receive various user interactions. Here, the user interface 120 may be implemented in various types according to an implementation of the display apparatus 100. When the display apparatus 100 is implemented with a digital TV, the user interface 120 may be implemented with a remote controller receiver configured to receive a remote controller signal from the remote control apparatus 200, a camera configured to sense a motion of the user, a microphone configured to receive a voice of the user, and the like. Further, when the display apparatus 100 is implemented with a touch-based portable terminal, the user interface 120 may be implemented in a touch screen form forming a mutual layer structure with a touch pad. At this time, the user interface 120 may be used as the above-described display 110.

<User Interaction with 3D Space>

The user interface 120 may sense various user interactions with a 3D UI according to an exemplary embodiment.

Specifically, the user interface 120 may sense a user interaction for displaying space elements, that is, a ceiling space, a wall space, and a floor space as a main space, and various user interactions input in a state in which the space elements are displayed as a main space.

The user interaction for displaying the space elements as a main space may have various types.

i) User Interaction According to User'S Motion

The user interaction may be input by a user's motion.

For example, a head up motion in which a user raises a user's head may be a user interaction for displaying a ceiling space as a main space, and a head down motion in which a user drops a user's head down may be a user interaction for displaying a floor space as a main space. Therefore, the user interface 120 may include a camera configured to image a user's head up and head down operations.

However, this is not limited thereto, and the user motion may be implemented in various types, such as a hand up and/or down motion, or a pupil up and/or down motion.

ii) User Interaction According to a Motion of Remote Control Apparatus 200

A user interaction may be input by a pointing motion of the remote control apparatus 200.

For example, a pointing up motion for moving the remote control apparatus 200 upward may be a user interaction for displaying a ceiling space as a main space, and a pointing down motion for moving the remote control apparatus 200 downward may be a user interaction for displaying a floor space as a main space. Therefore, the remote control apparatus 200 may include at least one of a geomagnetic sensor (for example, a 9-axis geomagnetic sensor), an acceleration sensor, and a gyro sensor, which are configured to sense a motion.

An optical joystick (OJ) sensor provided in the remote control apparatus 200 may be implemented to perform a trigger function. That is, when an interaction for pressing the OJ sensor for a preset time or more is input, the display apparatus 100 may determine the input as a trigger command for determining a motion of the remote control apparatus 200, and display an indicator configured to guide the motion of the remote control apparatus 200 on a screen of the display apparatus 100. Detailed description thereof will be made with reference to the accompanying drawings. In an interaction for pressing the OJ sensor for less than the preset time, the OJ sensor may be implemented to perform an ENTER function, for example, a function to select a specific cubic GUI and reproduce the cubic GUI on a screen in a state in which the cubic GUI is selected.

However, exemplary embodiments are not limited thereto, and a gesture motion of the remote control apparatus 200 may be input as the user interaction. For example, a specific gesture (pointing in an upward or downward direction) may be input as a gesture for displaying the ceiling space or the floor space.

iii) User Interaction According to Sensing of the OJ Sensor of the Remote Control Apparatus 200

A user interaction may be input through an operation on an OJ sensor provided in the remote control apparatus 200.

For example, an upward direction operation on the OJ sensor provided in the remote control apparatus 200 may be a user interaction for displaying a ceiling space as a main space, and a downward direction operation on the OJ sensor may be a user interaction for displaying a floor space as a main space. The OJ sensor is an image sensor configured to sense a user operation through an OJ, and operates like an upside-down optical mouse. That is, the user may only need to control the OJ with a finger for the OJ sensor to analyze a signal.

iv) User Interaction According to a Button Input of the Remote Control Apparatus 200

A user interaction may be input through a button operation of the remote control apparatus 200.

For example, a press operation of a first button provided in the remote control apparatus 200 may be a user interaction for displaying a ceiling space as a main space, and a press operation of a second button may be a user interaction for displaying a floor space as a main space.

v) User Interaction According to a Touch Panel Operation of Remote Control Apparatus 200

A user interaction may be input through an operation on a touch panel provided in the remote control apparatus 200.

For example, an upward dragging operation on the touch panel provided in the remote control apparatus 200 may be a user interaction for displaying a ceiling space as a main space, and a downward dragging operation on the touch panel may be a user interaction for displaying a floor space as a main space. The touch panel may include a resistive or capacitive sensor to sense a coordinate of a point at which the user touches. However, exemplary embodiments are not limited thereto, and the user interaction may include a case in which a text for identify a corresponding space, such as CEILING, UP, FLOOR, or DOWN on the touch panel is input.

vi) User Interaction According to Voice Recognition

A user interaction may be input through voice recognition in a microphone provided in the remote control apparatus 200 or a microphone separately provided.

For example, user voice recognition of “UP” may be a user interaction for displaying a ceiling space as a main space, and user voice recognition of “DOWN” may be a user interaction for displaying a floor space as a main space. However, a voice command is limited thereto, and the voice command may have various types such as “ABOVE” or “BELOW”.

The user interface 120 may sense a user interaction with a cubic GUI displayed in a floating form in a cubic room space including three walls when a wall space is displayed as a main space.

For example, the user interface 120 may sense various user interactions, such as a user interaction for selecting a cubic GUI, a user interaction for rotating a cubic GUI, a user interaction for changing a display angle of a cubic GUI, a user interaction for slicing a cubic GUI, a user interaction for changing a size, a location, and a depth of a cubic GUI, a user interaction for scrolling a surface of a cubic GUI, a user interaction for rubbing a surface of a cubic GUI, a user interaction with a single cubic GUI, and a user interaction with a group of cubic GUIs.

In addition, the user interface 120 may receive various user commands, such as a user interaction for changing a cubic GUI list, a user interaction for changing a display angle of a cubic room, a user interaction for changing a displayed cubic room into another cubic room, and a user interaction for changing a main display space (for example, a ceiling, a wall, or a floor) of the cubic room.

The controller 130 may function to control an overall operation of the display apparatus 100. For example, the controller 130 may include a microprocessor, a central processing unit (CPU), or an integrated circuit for executing programmable instructions.

### <Main Space Display According to User Interaction>

The controller 130 may control the display 110 to display one space element as a main space according to a user interaction sensed through the user interface 120.

Specifically, the controller 130 may control to display a region corresponding to a perspective of a user among a plurality of regions as a main region according to a changed perspective, and to provide a service corresponding to the main region, when the perspective of a user is changed according to the user interaction.

For example, the controller 130 may control to display the ceiling region as the main region when a user's head up interaction is received, and display the floor region as the main region when a user's head down interaction is received, in a state in which the wall region is displayed as the main region. Here, the term “displayed as the main space” refers to a state in which a corresponding space occupies a preset ratio of a full screen or more. For example, when the floor space is displayed as the main space, the floor space may be displayed in a central bottom portion of the screen, and a portion of the wall space may be displayed in a top of the screen. That is, when the floor space is displayed as the main space, a portion of polyhedral cubic GUIs included in the wall space may be displayed in the top of the screen. In some embodiments, the main space may include a form in which user interaction is sensed as an interaction with a corresponding space. That is, when only information is simply displayed in the main space, the user interaction may be sensed as an interaction with the main space only when it is needed to control the main space according to the user interaction.

The controller 130 may display a non-visual region in a pointing method or a pulling method. For example, when the remote control apparatus 200 is pointed upward, the ceiling space may be display in a cue method, and when the remote control apparatus 200 is pulled upward, the ceiling space may be displayed in a seamless method.

### <Various Embodiments for Service Provided in Space Elements>

When a specific space element is displayed in a main space, the controller 130 may provide a UI screen corresponding to the space. Here, the UI screen corresponding to the space may be a screen for providing at least one among information, a function, and a service corresponding to the space.

Specifically, the controller 130 may control to display a UI screen configured to provide information service when the ceiling region is displayed as the main region. Here, in one example, the information service may include a weather information providing service, but this is not limited thereto. That is, in another example, the information service may provide a variety of information such as stock information, a sport game schedule, or a TV schedule. The information provided in the ceiling space may be set as default, but may be changed according to a preference of the user. For example, even when it is set that weather information is to be provided as default, it may be set such that stock information may be provided in the ceiling space when a user preference for the stock information is received. Further, it may be set that two or more pieces of information different from each other may be provided.

Further, the controller 130 may control to display a UI screen configured to provide a commerce service when the wall space is displayed as the main region. Here, in one example, the commerce service may be a product purchase-related service, but this is not limited thereto. That is, in another example, the commerce service may provide a variety of commerce services such as content purchase, or application purchase.

In one example, the commerce service provided in the wall space may be a service for virtual purchase of a product for decoration of the wall space. Therefore, the product purchased through the commerce service may be arranged in the wall space. Here, the product may include wallpaper as well as an interior accessory disposable on the wall, such as a photo frame, a lamp, or a mirror. In one example, when the user purchases a virtual lamp, the virtual lamp purchased by the user may be disposed a default location or a location designated by the user in the wall space. The virtual lamp may perform an ON/OFF function like a real lamp, and thus the virtual lamp may perform a function to provide illumination in a cubic room. In another example, when a mirror is selected, the screen of the display apparatus 100 may perform a mirror function when the mirror is selected according to a user interaction.

The commerce service may be implemented in connection with real purchase of a product, and when the user purchases a real product, a virtual product is disposed in the wall space. When the virtual product is disposed in the wall space, and the real product is disposed for example, in home, the virtual product may operate in connection with the real product disposed in home. For example, when the user turns on/off a real lamp that is purchased and disposed in home, the virtual lamp may operate in the same manner as the real lamp. On the other hand, the user may control an operation of the real lamp through control of the virtual lamp.

The above-described product may be a graphic version of a product which is difficult to purchase. That is, when it is difficult for the user to purchase the real product, e.g., the real product is very expensive, the user may purchase the virtual graphic product, and dispose the virtual graphic product in the UI screen. Therefore, the user may have a sense of compensation and be satisfied.

The above-described exemplary embodiment illustrates a case in which the purchased virtual product is disposed on the wall, but this is not limited thereto, and a product such as a sofa disposed in a room may be disposed in a cubic room.

The commerce service provided in the wall space may be performed through a specific product seller provided in the wall space. For example, when a variety of product seller information is displayed in the wall space, and corresponding product seller information is selected, a variety of information about products sold by the product seller may be displayed and purchase may be made. At this time, a cubic GUI displayed in the cubic room may disappear from a screen temporarily. In some embodiments, various purchase screens configured to provide purchase service may be provided on a display screen of a remote control apparatus 200. For example, when the user wants to use the commerce service while operating multi-jobs, the purchase screen may be provided to the remote control apparatus 200 to ensure the user to view the screen.

The controller 130 may control to display a UI screen configured to provide control service when a floor space is displayed as the main space according to a user interaction. In one example, the control service may be a home device control service, but this is not limited thereto. In another example, the control service may include various types of control services such as an office control service or a specific control service.

Specifically, the controller 130 may display a 2D or 3D virtual space layout connected to a home network, and receive a control signal based on the displayed space layout to control a corresponding home device. That is, the space layout may include information for at least one home device connected to the home network, and the information may include identification information of the home device in the form of a text (for example, a name of the home device), or an image (for example, a real image of the home device, an external appearance image thereof, or an icon). When a control signal is received from the remote control apparatus 200 in a state in which a specific home device is identified, the controller 130 may control the specific home device according to the received control signal. At this time, the display apparatus 100 may operate as a home network server. However, when the home network server is implemented separately, the display apparatus 100 may transmit the received control signal to the home network server.

The space layout may be generated based on location information and a device type of each home device. Specifically, a virtual space layout may be generated based in the location information and the device type of each home device connected to the home network, and the space layout may be updated based on input location information whenever connection of an existing home device to the home network is released or a new home device is connected to the home network.

In some embodiments, when a specific home device is selected as a control target, the controller 130 may display a control screen for controlling the home device or a state providing screen for providing a state of the home device. In one example, when an air conditioner is selected, the control screen for controlling an operation of the air conditioner may be displayed.

In another example, when a refrigerator is selected, the controller 130 may display the state providing screen in which items currently included in the refrigerator are scanned and displayed. An image displayed on the state providing screen may be acquired through a camera provided inside the refrigerator. At this time, the user may check a desired item and directly order the desired item online, without a need to open the refrigerator. At this time, the commerce service provided in the wall space may be used.

When the floor space is displayed as the main space according to a user interaction, the controller 130 may provide, for example, a home security control service or a baby care service. In some embodiments, when an error occurs in the home security, the controller 130 may automatically display the floor space as the main space, and provide a home-security-related screen. For example, when an abnormal state is sensed from a sensor installed in home, the controller may display a corresponding space and allow the user to check the corresponding space. In one embodiment, when a closed circuit TV (CCTV) is installed in the space, the controller may provide an image captured in a point of time when the abnormal state is sensed. In another embodiment, when a bell rings at an entrance, the controller may automatically display the floor space as the main space, and display a door security image captured in a door lock camera.

The floor space may provide an office control service of the user, or the like. For example, a control service configured to control a device in an office of the user, such as a computer, an air conditioner, or a stove, may be provided. At this time, the remote control apparatus 200 may perform communication with the display apparatus through a cloud server (not shown). In particular, the remote control apparatus 200 may allow the display apparatus 100 to perform searching, opening and the like on a file stored in the computer in the office of the user through remote control so that the office control may be provided in home.

### <Various Embodiments of a Service Provided in Space Elements According to Category>

As described above, since the plurality of 3D spaces comprising the ceiling, the wall, and the floor are prepared to display different 3D spaces according to a rotation thereof, the types of the UI screens provided in the space elements according to characteristics of the spaces may be changed.

For example, types of information, functions, or services provided in the ceiling, wall, and floor spaces may be changed according to a category type corresponding to the 3D space, that is, the cubic room.

In one example, when the displayed cubic room corresponds to an application category, the wall space may provide an application-related commerce service. In another example, when the cubic room corresponds to an SNS category, the ceiling space may provide a video call image with a plurality of users represented by a plurality of cubic GUIs selected in the cubic room.

<Other Various Embodiments of Information or Functions Provided in Space Elements>

In some embodiments, the floor space may provide a cubic GUI representing a user's favorite item regardless of a category represented by the displayed cubic room other than the control service. That is, even when a cubic GUI corresponding to a specific category is provided in the cubic room, the floor space may provide cubic GUIs included in several categories.

In another example, the ceiling space may provide a video call function as default.

In still another example, when the ceiling space is displayed as the main ceiling space according to a user interaction in a state in which corresponding advertisement information is displayed in one surface of one of the plurality of cubic GUIs included in the displayed cubic room or displayed in all cubic GUIs, the ceiling space may provide an advertisement reproducing screen.

FIG. 2(b) is a block diagram illustrating a detailed configuration of a display apparatus 100 according to another exemplary embodiment. Referring to FIG. 2(b), the display apparatus 100 includes an image receiver 105, a display 110, a user interface 120, a controller 130, a storage 140, a communicator 150, an audio processor 160, a video processor 170, a speaker 180, a button 181, a camera 182, and a microphone 183. Detailed description of components illustrated in FIG. 2(b) that are substantially the same as those illustrated in FIG. 2(a) will be omitted.

The image receiver 105 receives image data through various sources. For example, the image receiver 105 may receive broadcast data from an external broadcasting station, receive image data from an external apparatus (for example, a digital versatile disc (DVD) player, a Blu-ray disc (BD) player, and the like), and receive image data stored in the storage 140. In particular, the image receiver 105 may include a plurality of image reception modules configured to receive a plurality of images to display a plurality of content selected by a cubic GUI on a plurality of screens. For example, the image receiver 105 may include a plurality of tuners to simultaneously display a plurality of broadcasting channels.

The controller 130 controls an overall operation of the display apparatus 100 using various programs stored in the storage 140.

Specifically, the controller 130 may include a random access memory (RAM) 131, a read only memory (ROM) 132, a main central processing unit (CPU) 133, a graphic processor 134, first to n-th interfaces 135-1 to 135-n, and a bus 136.

The RAM 131, the ROM 132, the main CPU 133, the graphic processor 134, the first to n-th interfaces 135-1 to 135-n, and the like may be electrically coupled to each other through the bus 136.

The first to n-th interfaces 135-1 to 135-n are coupled to the above-described components. One of the interfaces may be a network interface coupled to an external apparatus through a network.

The main CPU 133 accesses the storage 140 to perform booting using an operating system (O/S) stored in the storage 140. The main CPU 133 performs various operations using various programs, content, data, and the like stored in the storage 140.

A command set and the like for system booting is stored in the ROM 132. When a turn-on command is input to supply power, the main CPU 133 copies the O/S stored in the storage 140 to the RAM 131 according to a command stored in the ROM 132, and executes the O/S to boot a system. When the booting is completed, the main CPU 133 copies various application programs stored in the storage 140 to the RAM 131, and executes the application programs copied to the RAM 131 to perform various operations.

The graphic processor 134 generates a screen including various objects such as an icon, an image, a text, and the like using an operation unit (not shown) and a rendering unit (not unit). The operation unit calculates attribute values such as coordinate values, in which the objects are displayed according to a layout of a screen, shapes, sizes, and colors of the objects based on a received control command. The rendering unit generates a screen having various layouts including the objects based on the attribute values calculated in the operation unit. The screen generated in the rendering unit is displayed in a display area of the display 110.

The operation of the above-described controller 130 may be performed by the program stored in the storage 140.

The storage 140 stores a variety of data such as an O/S software module for driving the display apparatus 100, a variety of multimedia content, a variety of applications, and a variety of content input or set during application execution.

In particular, the storage 140 may store data for constituting various UI screens including a cubic GUI provided on the display 110 according to an exemplary embodiment.

Further, the storage 140 may store data for various user interaction types and functions thereof, provided information, and the like.

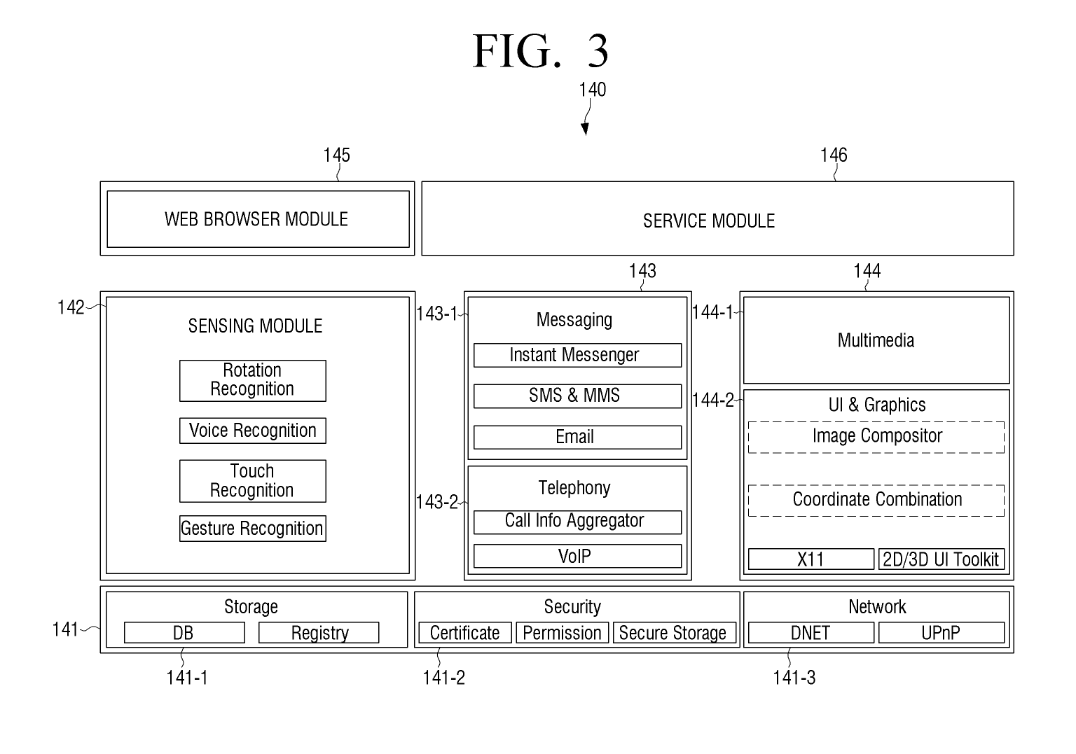

Various software modules stored in the storage 140 will be described with reference to FIG. 3.

Referring to FIG. 3, software including a base module 141, a sensing module 142, a communication module 143, a presentation module 144, a web browser module 145, and a service module 146 may be stored in the storage 140.

The base module 141 is a module configured to process signals transmitted from hardware included in the display apparatus 100 and transmit the processed signals to an upper layer module. The base module 141 includes a storage module 141-1, a security module 141-2, a network module 141-3, and the like. The storage module 141-1 is a program module configured to manage a database (DB) or a registry. The main CPU 133 accesses a database in the storage 140 using the storage module 141-1 to read a variety of data. The security module 131-2 is a program module configured to support certification to hardware, permission, secure storage, and the like, and the network module 141-3 is a module configured to support network connection, and may include a device Net (DNET) module, a universal plug and play (UPnP) module, and the like.

The sensing module 142 is a module configured to collect information from various sensors, and analyze and manage the collected information. The sensing module 142 may include a head direction recognition module, a face recognition module, a voice recognition module, a motion recognition module, a near field communication (NFC) recognition module, and the like.

The communication module 143 is a module configured to perform communication with an external apparatus. The communication module 143 may include a messaging module 143-1, such as a messenger program, a short message service (SMS) and multimedia message service (MMS) program, and an E-mail program, a call module 143-2 including a call information aggregator program module, a voice over internet protocol (VoIP) module, and the like.

The presentation module 144 is a module configured to construct a display screen. The presentation module 144 includes a multimedia module 144-1 configured to reproduce and output multimedia content, and a UI rendering module 144-2 configured to perform UI and graphic processing. The multimedia module 144-1 may include, for example, a player module (not shown), a camcorder module (not shown), a sound processing module (not shown), and the like. Accordingly, the multimedia module 144-1 operates to reproduce a variety of multimedia content, and to generate a screen and a sound. The UI rendering module 144-2 may include an image compositor module configured to composite images, a coordinate combination module configured to combine and generate coordinates on a screen in which an image is to be displayed, an X11 module configured to receive various events from hardware, and a 2D/3D UI toolkit configured to provide a tool for forming a 2D type or 3D type UI.

The web browser module 145 is a module configured to perform web browsing to access a web server. The web browser module 145 may include, for example, various modules, such as a web view module (not shown) configured to form a web page, a download agent module (not shown) configured to perform download, a bookmark module (not shown), and a web kit module (not shown).

The service module 146 is a module including various applications for providing a variety of services. Specifically, the service module 146 may include various program modules (not shown) for performing various programs such as an SNS program, a content-reproduction program, a game program, an electronic book program, a calendar program, an alarm management program, and other widgets.

Various program modules have been illustrated in FIG. 3, but the various program modules may be partially omitted, modified, or added according to a kind and a characteristic of the display apparatus 100. For example, the storage 140 may be implemented to further include a location-based module configured to support a location-based service in connection with hardware such as a global positioning system (GPS) chip.

The communicator 150 may perform communication with an external apparatus according to various types of communication methods.

The communicator 150 may include various communication chips such as a wireless fidelity (WIFI) chip 151, a Bluetooth chip 152, or a wireless communication chip 153. The WIFI chip 151 and the Bluetooth chip 152 perform communication in a WIFI manner and a Bluetooth manner, respectively. When the WIFI chip 151 or the Bluetooth chip 152 is used, the communicator 150 may first transmit and/or receive a variety of connection information such as a service set identifier (SSID) and a session key, perform communication using the information, and transmit and/or receive a variety of information. The wireless communication chip 153 is a chip configured to perform communication according to various communication standards, such as Institute of Electrical and Electronics Engineers (IEEE), Zigbee, 3rd generation (3G), 3rd Generation Partnership Project (3GPP), or Long Term Evolution (LTE). In addition, the communicator 150 may further include an NFC chip configured to operate in an NFC manner using a band of 13.56 MHz among various radio frequency identification (RF-ID) frequency bands such as 135 kHz, 13.56 MHz, 433 MHz, 860 to 960 MHz, and 2.45 GHz.

In particular, the communicator 150 may perform communication with a server (not show) configured to provide content or a service, or a server (not shown) configured to provide a variety of information, and receive a variety of information for determining a size and an arrangement state of cubic GUIs. For example, the communicator 150 may perform communication with an SNS server (not shown) to receive a plurality of pieces of user information (for example, profile photos, and the like) represented by cubic GUIs in an SNS service providing screen, or to receive associated information between users for determining the size and the arrangement state of the cubic GUIs. In another example, the communicator 150 may perform communication with a content providing server (not show) to receive content information represented by each of the cubic GUIs in a content providing screen, or associated information between contents.

The audio processor 160 is configured to perform processing on audio data. The audio processor 160 may variously perform processing such as decoding, amplification, and noise filtering on the audio data.

In particular, when a cubic GUI may be rotated according to a user's motion in accordance with an exemplary embodiment, the audio processor 160 may process the audio data to provide a sound according to a speed of the user's motion. For example, the audio processor 160 may generate a feedback sound corresponding to the speed of the user's motion and provide a generated feedback sound.

The video processor 170 is configured to perform processing on video data. The video processor 170 may variously perform image processing such as decoding, scaling, noise filtering, frame rate conversion, and resolution conversion on the video data.

The speaker 180 is configured to output various alarm sounds or voice messages as well as a variety of audio data processed in the audio processor 160.

The button 181 may include various types of buttons, such as a mechanical button, a touch pad, or a wheel, which may be provided in arbitrary regions of an exterior of a main body of the display apparatus 100, such as a front side, a lateral side, or a rear side. For example, a button for power-on/off of the display apparatus 100 may be provided.

The camera 182 is configured to image a still image or a moving image according to control of the user. In particular, the camera 182 may image various user motions for controlling the display apparatus 100.

The microphone 183 is configured to receive a user's voice or another sound, and convert the received user's voice or the sound into audio data. The controller 130 may use the user's voice input through the microphone 183 during a call or may convert the user's voice into audio data, and store the audio data in the storage 140. The camera 182 and the microphone 183 may be a configuration of the above-described user interface 120 according to a function thereof.

When the camera 182 and the microphone 183 are provided, the controller 130 may perform a control operation according to the user's voice input through the microphone 183 or the user motion recognized by the camera 182. That is, the display apparatus 100 may operate in a motion control mode or a voice control mode. When the display apparatus 100 operates in the motion control mode, the controller 130 activates the camera 182 to image the user, traces a change in motion of the user, and performs a control operation corresponding to the motion change. When the display apparatus 100 operates in the voice control mode, the controller 130 analyzes a user's voice input through the microphone, and operates in the voice recognition mode which performs a control operation according to the analyzed user's voice.

When the display apparatus 100 operates in the motion control mode, the controller 130 may control to display the ceiling space or the floor space as the main space according to a user's head up and/or down motion. Specifically, the head up and/or down motion may be detected by at least one from among a location of a face region of the user, a location of an eyeball, a length of a neck of the user, and a head region of the user.

For example, the controller 130 may determine the face region of the user, and determine the head up and/or down motion based on a location, an area, and the like of the face region, or determine the head up and/or down mode based on the location in the eyeball of the user.

Specifically, the controller 130 identifies an eyeball image from an image of the user imaged by the camera 182 through face modeling technology. The face modeling technology is an analysis process for processing a facial image acquired by an imaging unit and for converting the processed facial image to digital information for transmission. The face modeling technology may include an active shape modeling (ASM) method and an active appearance modeling (AAM) method. The controller 130 may determine the movement of the eyeball using the identified eyeball image, and determine the head up and/or down motion using the movement of the eyeball. For example, the controller 130 may scan a captured image of the user in pixel units, detect a pixel coordinate value corresponding to a location of the left eye of the user and a pixel coordinate value corresponding to a location of the right eye of the user, and determine a moving state of the location of the eyeball of the user. The method of detecting an eyeball's location by scanning the image of the user captured by a camera in pixel units, and detecting the eyeball's location of the user as the pixel coordinate value may be implemented using various image analysis method widely known, and thus detailed description thereof will be omitted. In the method of detecting the eyeball's location of the user, an infrared (IR) sensor may be used other than the camera.

Alternatively, the controller 130 may identify a face image and a neck image from the captured image of the user, and determine the head up and/or down motion based on a ratio between a length of the face and a length of the neck. For example, a threshold ratio between the length of the face and the length of the neck may be calculated in advance and pre-stored. The controller 130 may compare the pre-stored data with data of the user, i.e., the threshold ratio with a current ratio, to determine the head up and/or down motion.

In addition, the display apparatus 100 may further include various external input ports for connection to various external terminals, such as a headset, a mouse, and a local area network (LAN).

Although not shown in drawings, the display apparatus 100 may further include a feedback providing unit (not shown). The feedback providing unit (not shown) functions to provide various types of a feedback (for example, an audio feedback, a graphical feedback, a haptic feedback, and the like) according to the displayed screen. In one embodiment, the audio feedback may be provided to draw user's attention.

FIG. 2(b) illustrates an example of a detailed configuration included in the display apparatus 100, and in some exemplary embodiments, portions of components illustrated in FIG. 2(b) may be omitted or modified, and other components may be added. For example, when the display apparatus 100 is implemented with a portable phone, the display apparatus 100 may further include a GPS receiver (not shown) configured to receive a GPS signal from a GPS satellite, and calculate a current location of the display apparatus 100, and a digital multimedia broadcasting (DMB) receiver (not shown) configured to receive and process a DMB signal.

FIGS. 4A and 4B are views illustrating UI screens according to an exemplary embodiment.

Referring to FIG. 4A, a UI screen according to an exemplary embodiment may provide a rotatable GUI including room-shaped 3D spaces, that is, cubic rooms 410, 420, 430, 440, 450. Specifically, the cubic rooms 410 to 450 may be provided in edge portions of a space having a shape similar to a roulette wheel, and the cubic rooms 410 to 450 may correspond to different categories.

Category information corresponding to each of the cubic rooms 410 to 450 may be displayed in a corresponding one of the cubic rooms 410 to 450. For example, icons 411, 421, 431, 441, 451 symbolizing categories and simple text information 412, 422, 432, 442, 452 for the categories may be displayed in the cubic rooms 410 to 450, respectively. As illustrated in FIG. 4A, the categories may include an “ON TV” category for watching TV in real time, a “Movies & TV shows” for providing VOD content, a “Social” category for sharing SNS content, an “application” category for providing applications, a “Music, Photos & Clips” for providing personal content, and the like. However, the above categories are merely exemplary, and the categories may be provided according to various criteria.

When a specific cubic room is selected, the information 412 representing the specific cubic room is displayed with highlight to indicate that the cubic room is selected.

As illustrated in FIG. 4B, the cubic rooms are rotated according to a user interaction to be displayed. That is, a cubic room located in a center according to the rotation may be identified, and the cubic room may be selected according to a preset event occurring in a state in which the cubic room is identified, and a cubic GUI included in the selected cubic room may be displayed.

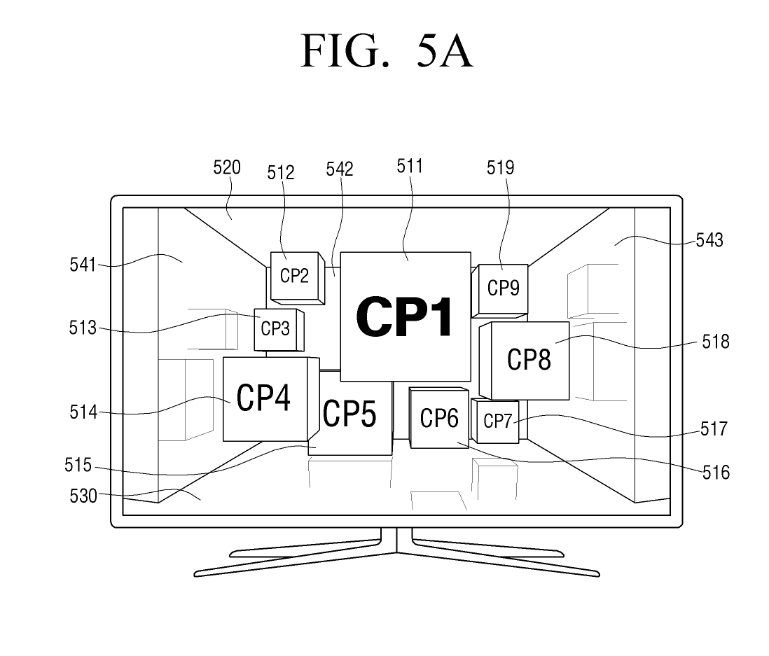

FIG. 5A illustrates a case in which a specific cubic room is selected according to a user interaction in the UI screen illustrated in FIGS. 4A and 4B.

When the specific cubic room is selected, a plurality of cubic GUIs CP1 to CP9 511 to 519 according to an exemplary embodiment may be displayed in a floating form in a 3D space, as illustrated in FIG. 5A. In FIG. 5A, the 3D space may be a space (cubic room) having a room shape formed by three walls 541, 542, 543, a ceiling 520, and a floor 530. The walls 541 to 543 are arrayed along an X-axis of a screen and have preset depths along a Z-axis.

As illustrated in FIG. 5A, the plurality of cubic GUIs CP1 to CP9 511 to 519 may represent predetermined objects. Specifically, the plurality of cubic GUIs CP1 to CP9 511 to 519 may represent a variety of objects included in a category corresponding to the selected cubic room. For example, when the selected cubic room corresponds to a VOD content-based category, the plurality of cubic GUIs CP1 to CP9 511 to 519 may represent various content providers who provide VOD content. However, the plurality of cubic GUIs CP1 to CP9 511 to 519 are merely exemplary, and a plurality of cubic GUIs may represent content (for example, specific VOD content) provided by content providers according to a menu depth progressed according to the user command.

As illustrated in FIG. 5A, the plurality of cubic GUIs CP1 to CP9 511 to 519 may be displayed in different sizes and arrangement states. The sizes and arrangement states of the cubic GUIs CP1 to CP9 511 to 519 may be changed according to a priority. In one embodiment, the priority may be set according to at least one of a user behavior pattern and an object attribute. Specifically, when content having a higher priority according to, for example, a preference of the user, the cubic GUI 511 representing a user's favorite content provider may be displayed in a central portion of a screen to have a larger size and a smaller depth than other cubic GUIs. That is, the plurality of cubic GUIs CP1 to CP9 511 to 519 may be displayed to reflect a preference of the user for an object, and thus may provide an effect of increasing a recognition rate of the user for the cubic GUI 511. Other cubic GUIs 512 to 519 may also be displayed to have sizes, locations, and depths according to preferences corresponding thereto.

The user behavior pattern may be analyzed with respect to a specific user according to a user certification process. For example, the UI according to an exemplary embodiment may be implemented to provide a plurality of users with different UI screens through certification of the user. That is, since a plurality of users, even family members may have different behavior patterns, preferences, and the like from one another, a UI screen corresponding to a behavior pattern of a corresponding user may be provided after a certificate process such as login is performed.

As illustrated in FIG. 5B, a pointing GUI 10 may be displayed around the cubic GUI 511 representing an object having a higher priority. Here, the pointing GUI 10 may be displayed on a cubic GUI according to a user command, and may be provided in a highlight pointer form as illustrated. However, the type of the pointing GUI is merely exemplary, and the pointing GUI may be modified in various forms such as an arrow-shaped pointer or a hand-shaped pointer.

The pointing GUI 10 may move according to various types of user commands. For example, the pointing GUI 10 may move to another cubic GUI according to various user commands such as a motion command in a pointing mode of the remote control apparatus 200, a motion command in a gesture mode, a voice command, a direction key operation command provided in the remote control apparatus 200, and a motion command according to head (or eye) tracking.

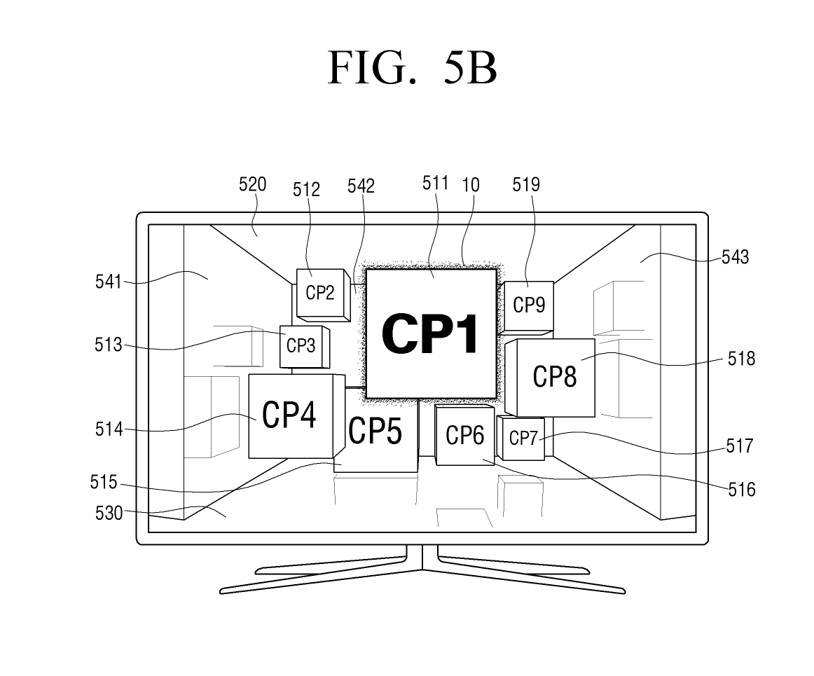

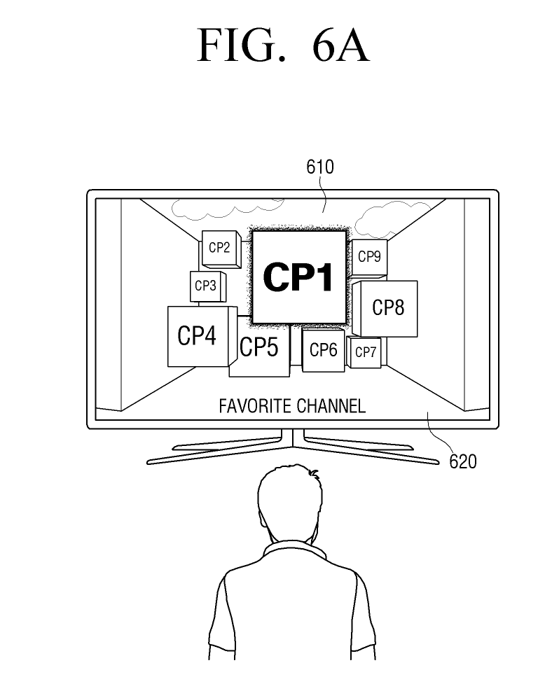

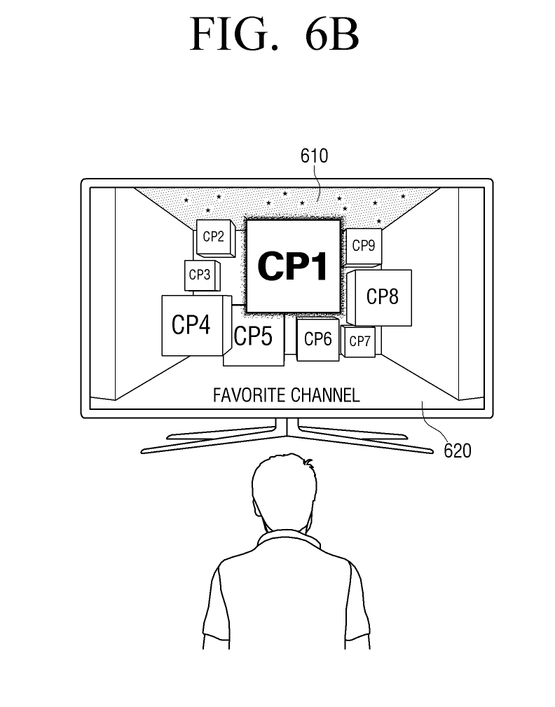

FIGS. 6A and 6B are views illustrating a UI screen according to an exemplary embodiment.

As illustrated in FIGS. 6A and FIG. 6B, when a wall space of a cubic room is displayed as a main space, a graphic representing, for example, current weather or a current time zone may be displayed in a ceiling space 610. Information representing a category of the currently displayed cubic room may be displayed in a floor space 620.

For example, as illustrated in FIG. 6A, when the current time zone is a day time zone, a graphic (e.g., blue sky) representing the day time zone may be displayed in the ceiling space 610. Also, when the category of the currently displayed cubic room is favorite channel, the information representing the category of favorite channel is displayed in the floor space 620.

Further, as illustrated in FIG. 6B, when the current time zone is a night time zone, a graphic (e.g., dark sky) representing the night time zone may be displayed in the ceiling space 610.

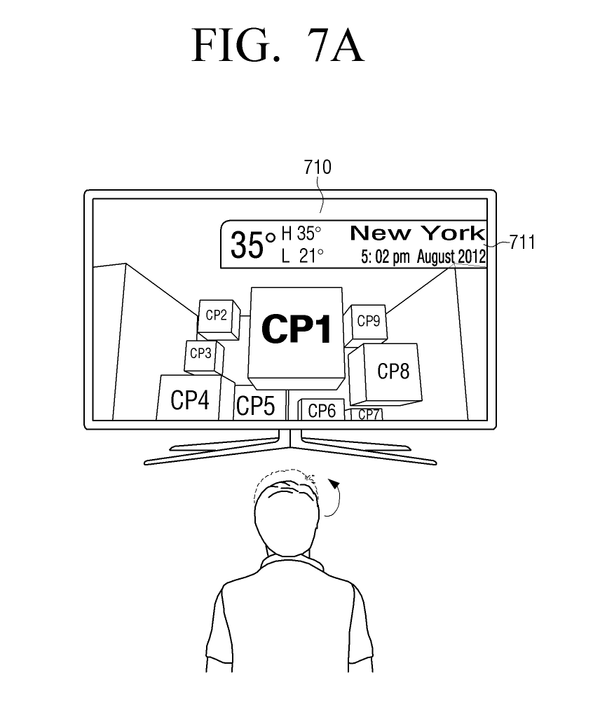

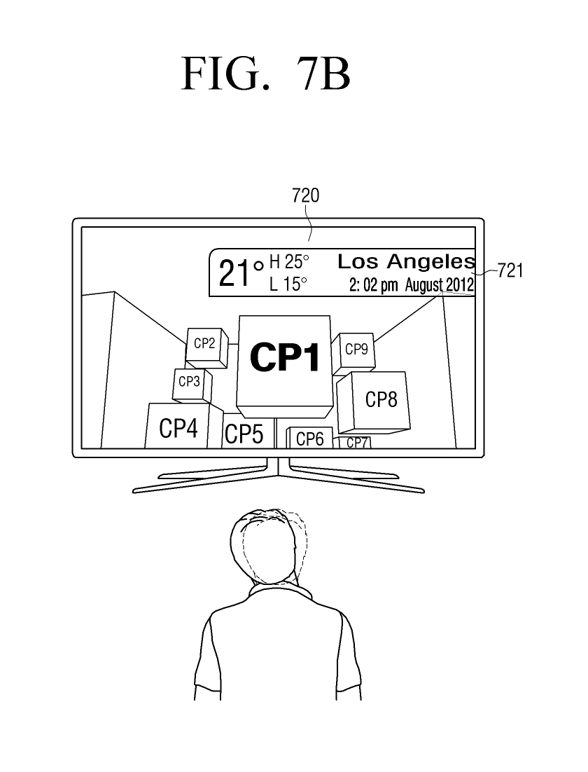

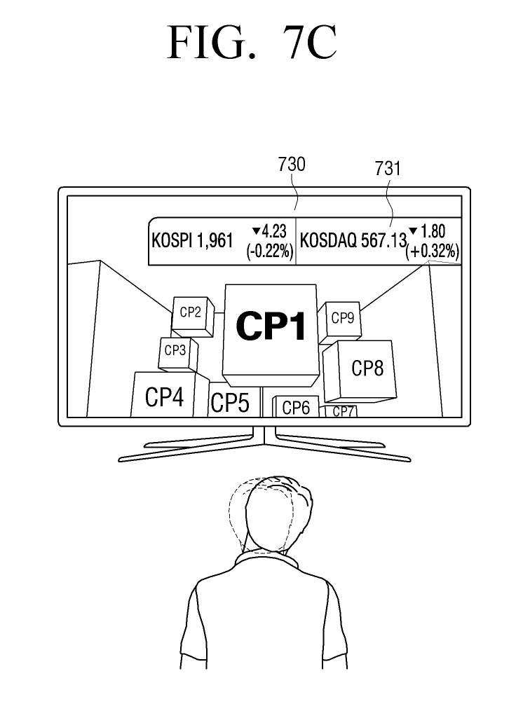

FIGS. 7A to 7C are views illustrating UI screens provided in a ceiling space according to various exemplary embodiments.

In state in which a wall space is displayed as a main space as illustrated in FIGS. 6A and 6B, when a user's head up interaction is sensed, as illustrated in FIG. 7A, a ceiling space 710 is displayed as the main space and weather information 711 may be displayed. At this time, the weather information 711 may be weather information of an area in which the user is located.

Subsequently, as illustrated in FIG. 7B, when an interaction in which the user bends the user's head to the left or rotates the user's head to the left is sensed, the ceiling space may be rotated such that a new ceiling space 720 may be displayed, and weather information 721 of another area may be provided. Here, in an exemplary embodiment, the other area may be an area previously selected by the user. For example, the user may previously set an area in which a family of the user is located as an area for receiving the weather information 721.

As illustrated in FIG. 7C, when an interaction in which the user bends the user's head to the right or rotates the user's head to the right is sensed, the ceiling space may be rotated such that a new ceiling space 730 may be displayed, and stock information 731 may be displayed.

As illustrated in FIGS. 7A to 7C, when a new ceiling space is displayed according to a user interaction received in a state in which a ceiling space is displayed as the main space, the same type of new information may be provided (see FIG. 7B) or a different type of new information may be displayed (see FIG. 7C).

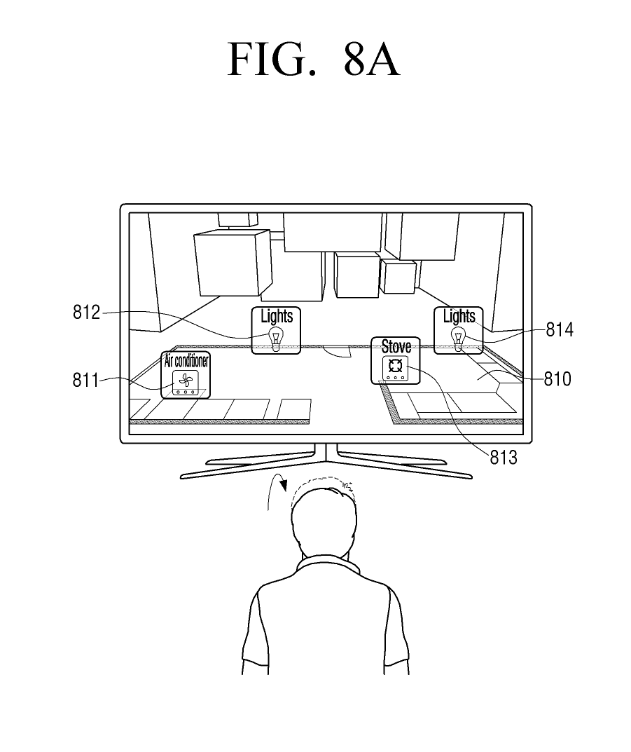

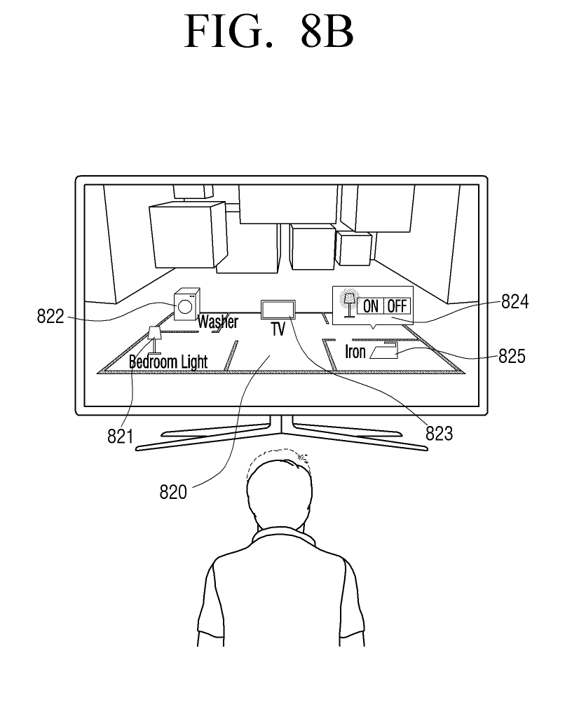

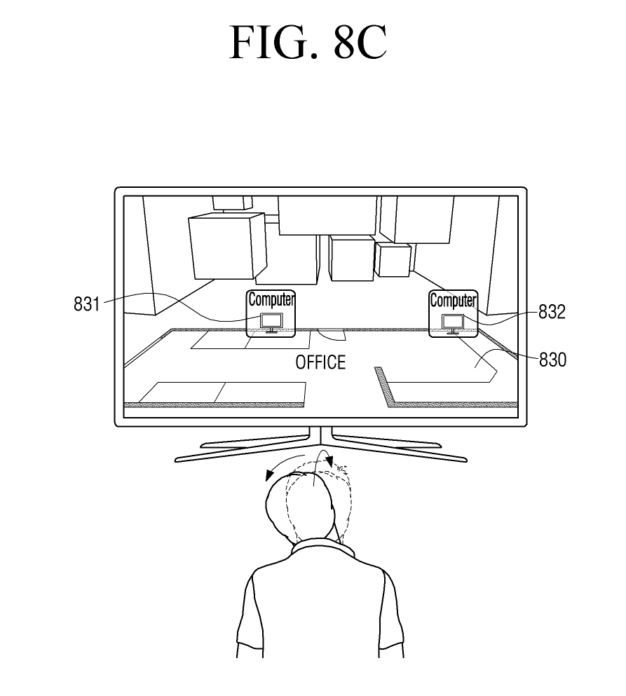

FIGS. 8A to 8C are views illustrating UI screens provided in a floor space according to various embodiments.

In state in which a wall space is displayed as a main space as illustrated in FIGS. 6A and 6B, when a user's head down interaction is sensed, as illustrated in FIG. 8A, a floor space 810 is displayed as the main space, and a home control screen may be provided. For example, as illustrated in FIG. 8A, a space layout including icons 811 to 814 which represent respective home devices may be displayed.

At this time, the user may control an operation of a specific home device through a control screen or a control menu displayed by selecting an icon for the specific home device.

Alternatively, as illustrated in FIG. 8B, the home control screen may be provided in a form in which icons 821 to 825 representing respective home devices are located in virtual locations corresponding to real locations thereof on a space layout 820. In one embodiment, external appearances of home devices may be displayed in a 3D manner.

As illustrated in FIG. 8C, when an interaction in which the user bends the user's head to the right or rotates the user's head to the right is sensed, the floor space may be rotated such that a new floor space 830 may be displayed, and a new control screen may be provided. For example, a control screen configured to control office devices represented by icons 831 and 832 of the user may be provided. At this time, the user may remotely control the office devices at home.

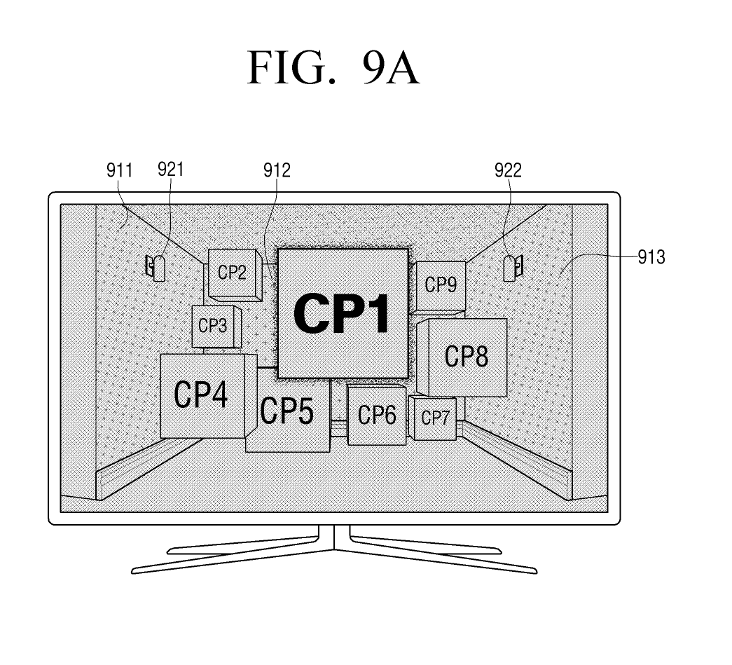

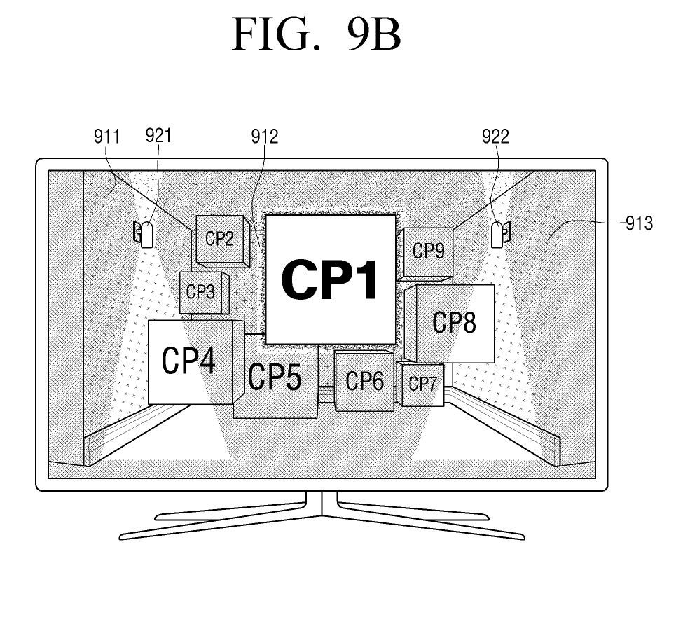

FIGS. 9A and 9B illustrate UI screens provided in a wall space according to various exemplary embodiments.

As illustrated in FIG. 9A, when a wall space is displayed as a main space, a cubic room comprising three walls 911 to 913 may be provided. Cubic GUIs may be displayed in a floating form in the cubic room. This has already been described above, and thus detailed description thereof will be omitted.

A virtual accessory purchased by the user may be disposed on at least one of the three walls 911 and 913. For example, as illustrated in FIGS. 9A and 9B, a plurality of lamps 921 and 922 may be disposed on right and left walls 911 and 913.

The accessories provided on the walls 911 and 913 may be controlled by the user. For example, as illustrated in FIGS. 9A and 9B, the plurality of lamps 921 and 922 may turn on and/or off according to a user interaction to provide illumination within the cubic room. FIG. 9A illustrates a screen in which the plurality of lamps 921 and 922 is turned off, and FIG. 9B illustrates a screen in which the plurality of lamps 921 and 922 are turned on.

The purchase of the accessory may be performed through a commerce service provided on at least one of the three walls, and in some embodiments, the purchase of the accessory may be performed through a commerce service provided through one among cubic GUIs displayed in the cubic room.

In another embodiment, a commerce service may be performed in connection with real purchase of an accessory, and when the user purchases a real accessory, the accessory may be disposed on, for example, a wall. When a virtual accessory is disposed on the wall, and a real accessory is disposed at home, the virtual accessory may operate in connection with the real accessory disposed at home. For example, when the user turns on a lamp as the real accessory, the virtual lamp may operate the same manner as the real lamp. Alternatively, the user may control the operation of the real lamp through control of the virtual lamp.

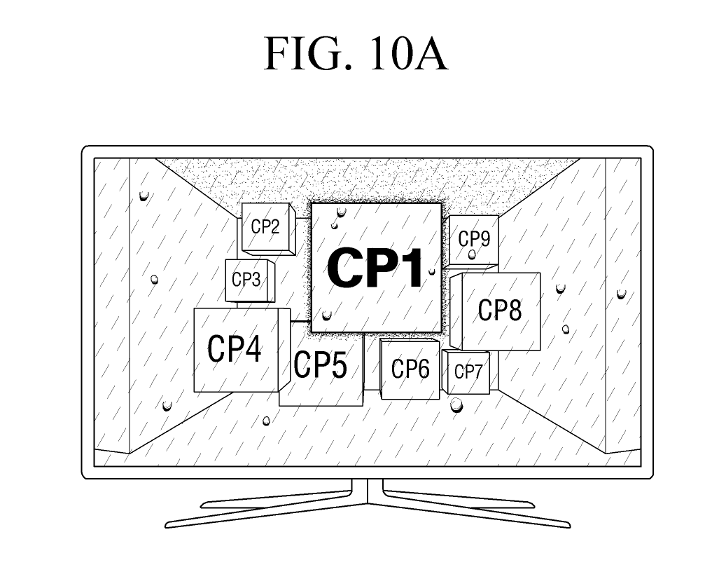

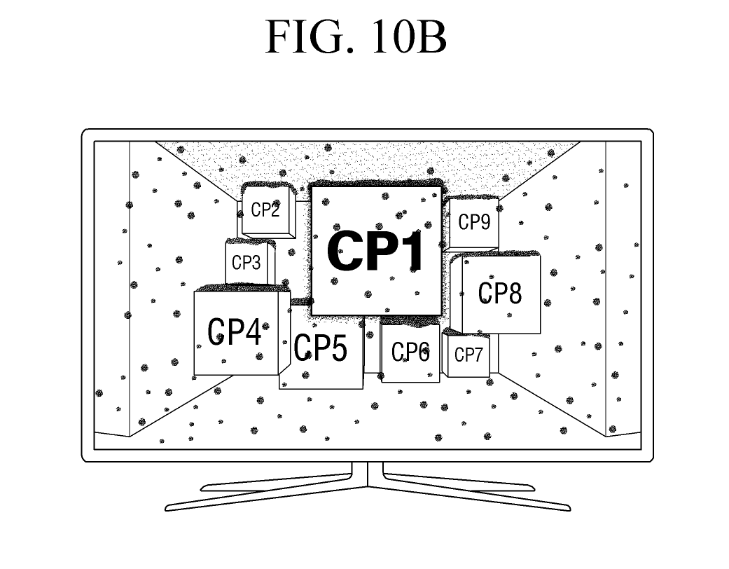

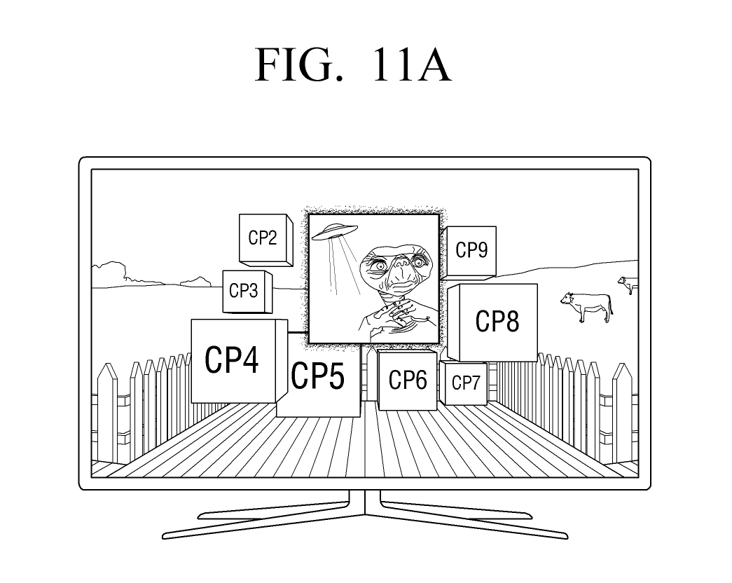

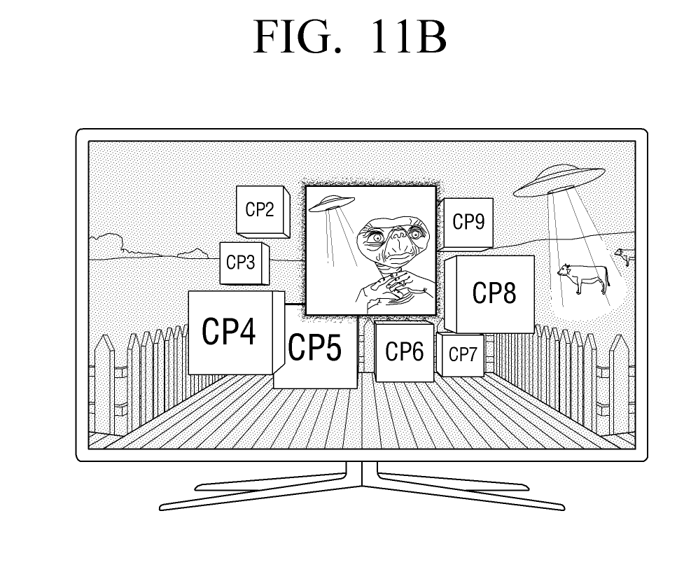

FIGS. 10A to 11B are views illustrating background screens provided in a ceiling space according to various exemplary embodiments.

As illustrated in FIGS. 10A and 10B, when a cubic room is displayed as a main space, a graphic effect with current weather information may be provided on a background. For example, when it is raining at present, as illustrated in FIG. 10A, a graphic effect of a rainy weather is provided, and when it snows, a graphic effect of a snow weather is provided. At this time, a live effect as if it rains or snows may be provided, e.g., rain drops as in FIG. 10A or falling snow as in FIG. 10B may be displayed in the cubic room. The graphic effect may be displayed in an on screen display (OSD) form having a transparent. In some embodiments, a corresponding image may be newly rendered to be displayed.

As illustrated in FIGS. 11A and 11B, when the cubic room is displayed as a main space, a wall space may disappear, and various background screens may be provided.

Specifically, as illustrated in FIGS. 11A and 11B, a corresponding background may be displayed according to an attribute of a cubic GUI selected by the user. For example, when content of an SF genre is selected, a background matching the genre may be provided. At this time, the displayed background may provide various animation effects.

In some embodiments, the background may be automatically provided when a preset event is generated in the display apparatus. For example, when a user interaction is not received for a preset time or more, the background may be displayed.

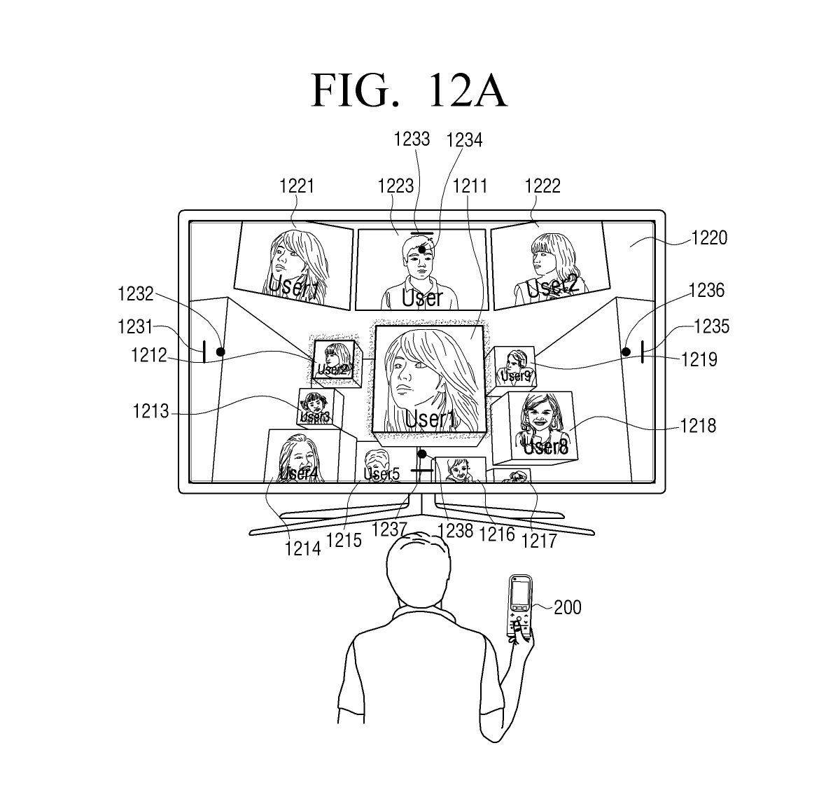

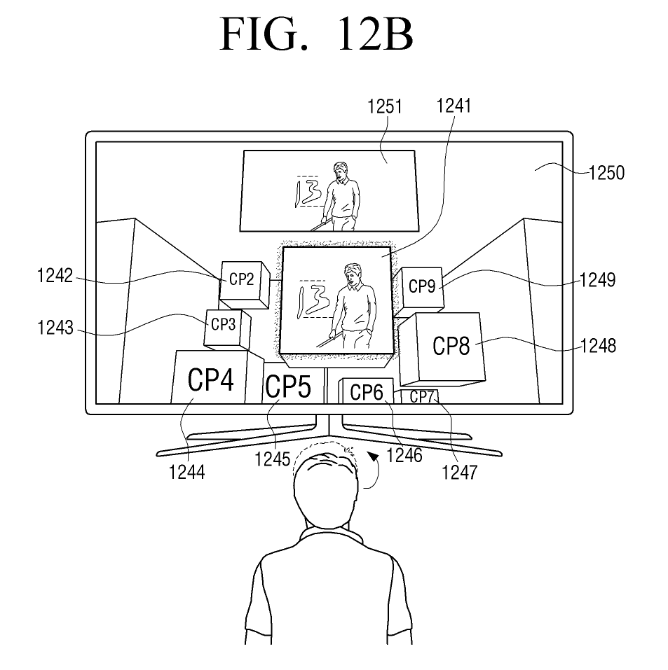

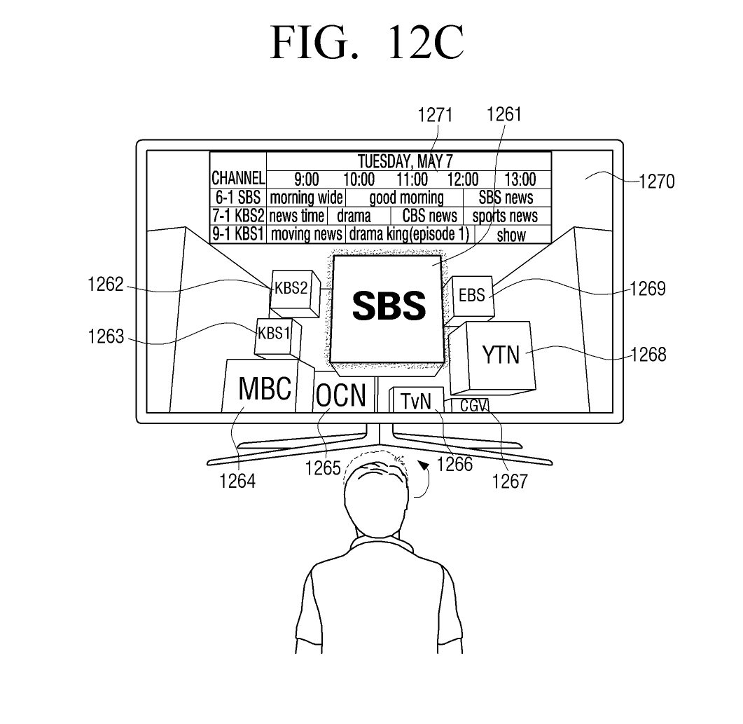

FIGS. 12A to 12C are views illustrating a function or information providable in a ceiling space according to various exemplary embodiments.

As illustrated in FIG. 12A, when a ceiling space 1220 is displayed as a main space according to a user's head up interaction, a function related to a category corresponding to a cubic room may be provided in the ceiling space 1220.

In an example, as illustrated in FIG. 12A, after at least one cubic GUI, that is, cubic GUIs 1211 and 1212 are selected in a state in which a displayed cubic room corresponds to an SNS category and cubic GUIs 1211 to 1219 in the cubic room represent a plurality of users, when a user interaction for selecting the ceiling space 1220 is received, a video call image for users corresponding to the selected cubic GUIs 1211 and 1212 may be provided in the ceiling space 1220. As illustrated in FIGS. 12A, multi screens 1221 to 1223 providing images of users User 1 and User 2 corresponding to the selected cubic GUIs 1211 and 1212 and a user User of the display apparatus 100 may be displayed.

At this time, the user interaction may be input according to a motion interaction of the remote control apparatus 200.

Specifically, when an OJ sensor provided in the remote control apparatus 200 is pressed for a preset time or more, the display apparatus 100 may sense a corresponding input as a trigger command, and start to sense a motion of the remote control apparatus 200 using, for example, a 9-axis sensor. A signal corresponding to the pressing operation may be transmitted to display apparatus 100, and the display apparatus 100 may display an indicator (1231 to 1238) for guiding the motion of the remote control apparatus 200. At this time, the indicator may include a first indicator (1232, 1234, 1236, 1238) indicating the motion of the remote control apparatus 200 in lateral and longitudinal directions, and a second indicator (1231, 1233, 1235, 1237) for indicating a threshold range of the motion of the remote control apparatus 200 to be detected.

The first indicator (1232, 1234, 1236, 1238) may change a size and/or a location thereof according to the motion of the remote control apparatus 200. For example, when the remote control apparatus 200 moves upward after the trigger command is input, the first indicator (1232, 1234, 1236, 1238) corresponding to the motion of the remote control apparatus 200 among the plurality of indicators (1231 to 1238) may change the size and/or the location thereof according to the motion of the remote control apparatus 200 moving upward.

In particular, when the first indicator (1232, 1234, 1236, 1238) moves according to the motion of the remote control apparatus 200 to be in contact with the second indicator (1231, 1233, 1235, 1237), the remote control apparatus 200 may transmit a command for converting the screen of the display apparatus 100 to the display apparatus 100 according to a direction of the motion of the remote control apparatus 200.

For example, the screen may be converted such that the ceiling space 1220 is displayed as the main space.

In another example, as illustrated in FIG. 12B, after at least one cubic GUI 1241 is selected in a state in which a displayed cubic room corresponds to a VOD category and cubic GUIs 1241 to 1249 in the cubic room represent content providers or content, when a user's head up interaction is received, a screen 1251 providing a preview image, an advertisement image, and the like corresponding to the selected cubic GUI 1241, may be displayed in a ceiling space 1250.

In still another example, as illustrated in FIG. 12C, in a state in which a displayed cubic room corresponds to a broadcasting channel category and cubic GUIs 1261 to 1269 in the cubic room represent broadcasting channels, when a user's head up interaction is received, a TV schedule 1271 may be displayed in a ceiling space 1270. Alternatively, when a user's head up interaction is received in a state in which a specific cubic GUI 1261 is selected, the broadcasting channel schedule represented by the specific cubic GUI 1261 may be displayed.

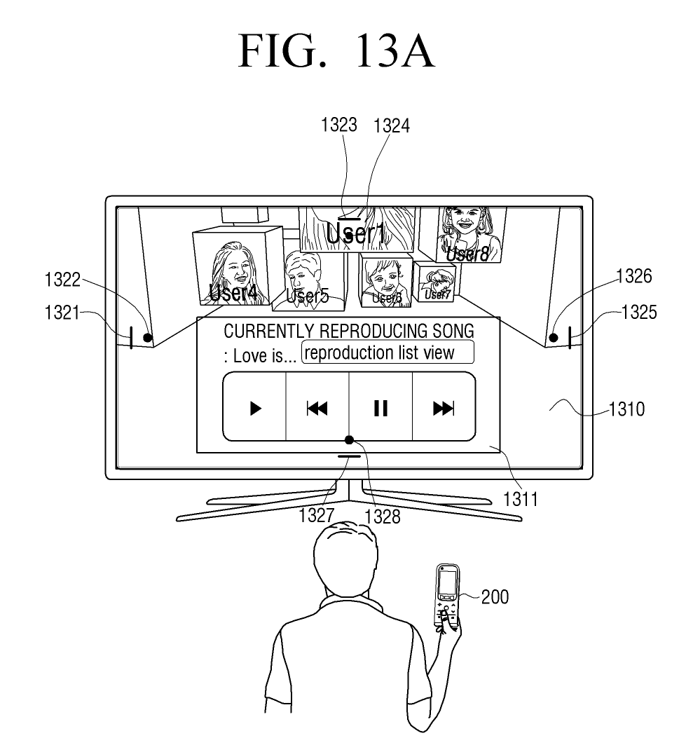

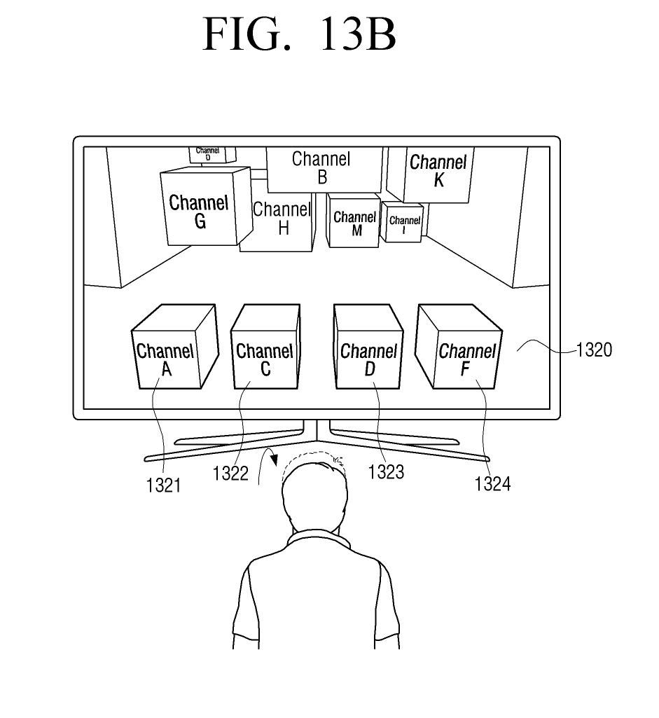

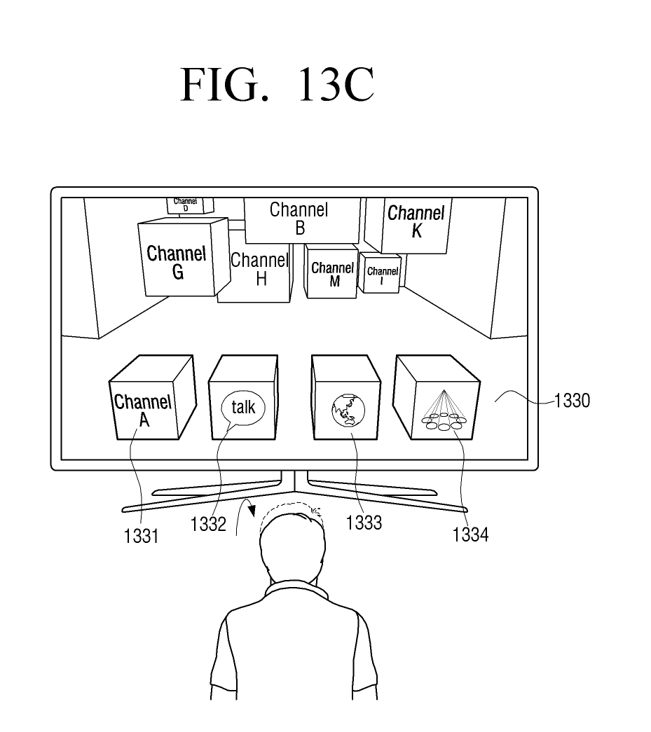

FIGS. 13A to 13C are views illustrating a function or information providable in a floor space according to various exemplary embodiments.

As illustrated in FIGS. 13A and 13B, when a floor space 1310 is displayed as a main space according to a user's head down interaction, a function related to a category corresponding to a cubic room may be provided in the floor space 1310.

In an example, as illustrated in FIG. 13A, in a state in which a displayed cubic room corresponds to an SNS category and a plurality of cubic GUIs in the cubic room represent a plurality of users, when a user interaction is received, a music reproducing screen 1311 for controlling reproducing music provided in an SNS server may be provided in the floor space 1310. In some embodiments, the music reproducing screen 1311 may be provided according to setting of the user regardless of the category in the floor space 1310. At this time, the user interaction may be input according to a motion interaction of the remote control apparatus 200. A method of detecting the motion interaction may be the same as that described in FIG. 12A, and detailed description thereof will be omitted.

In another example, as illustrated in FIG. 13B, in a state in which a displayed cubic room corresponds to a broadcasting channel category and a plurality of cubic GUIs in the cubic room represent broadcasting channels, when a user's head down interaction is received, cubic GUIs 1321 to 1324 representing broadcasting channels registered to Favorites by the user may be displayed in a floor space 1320.

As illustrated in FIG. 13C, cubic GUIs 1331 to 1334 representing a user's favorite objects may be displayed regardless of the category in the floor space 1330 displayed as a main according to a user's head down interaction. For example, the cubic GUI 1331 included in a broadcasting channel category, the cubic GUI 1332 included in an SNS category, the cubic GUI 1333 included in a communication category, and the cubic GUI 1334 included in an application category may displayed in the floor space 1330.

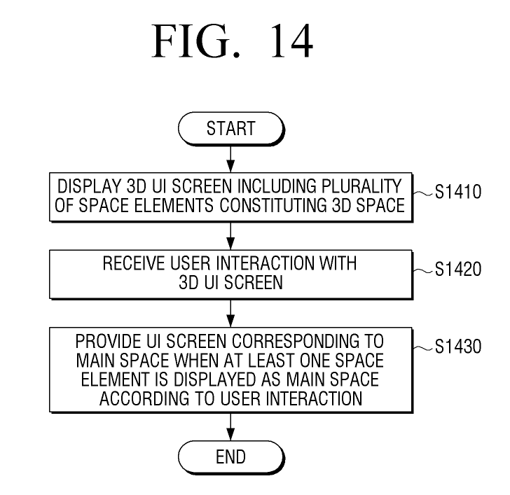

FIG. 14 is a flowchart illustrating a UI screen providing method according to an exemplary embodiment.

According to the GUI screen providing method of a display apparatus, a GUI screen configured to include at least one polyhedral icon and correspond to a plurality of perspectives of the user illustrated in FIG. 14 is provided. First, a user interaction with the GUI screen is received (S1410).

Subsequently, a GUI screen corresponding to at least one perspective among the plurality of perspectives is provided according to the received user interaction (S1420).

Here, the GUI screen corresponding to the plurality of perspectives may provide at least one from among information, functions, and services mapped to the plurality of perspectives, respectively.

At this time, the GUI screen corresponding to the plurality of perspectives may include a GUI screen corresponding to the ceiling space, a GUI screen corresponding to the wall space, and a GUI screen corresponding to the floor space.

In one embodiment, when the ceiling space is displayed as the main space according to a user interaction, a GUI screen, for example, providing an information service may be displayed. At this time, for example, the information service may include a weather information providing service.

In one embodiment, when the wall space is displayed as the main space according to a user interaction, a GUI screen providing a commerce service may be displayed. At this time, for example, the information service may include weather information providing service.

In one embodiment, when the floor space is displayed as the main space according to a user interaction, a GUI screen providing a control service may be displayed. At this time, the control service may include, for example, at least one of a home device control service and a home security control service.

In a state in which the wall space is displayed as the main space, the user interaction for displaying the ceiling space as the main space may be a head up interaction of the user, and the user interaction for displaying the floor space as the main space may be a head down interaction of the user.

Further, a background screen of a space element may be displayed by reflecting external environment information.

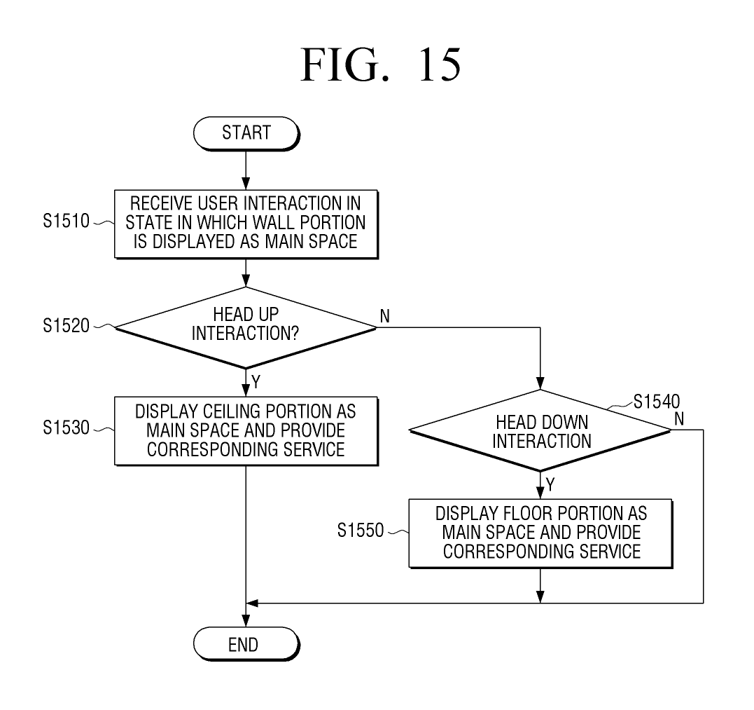

FIG. 15 is a flowchart illustrating a UI screen providing method according to another exemplary embodiment.

According to the UI screen providing method illustrated in FIG. 15, first, a user interaction is received in a state in which a wall space is displayed as the main space (S1510). Here, the wall space may be a space formed by three walls as in the above-described cubic room.

Subsequently, it is determined whether or not the received user interaction is a head up interaction (S1520).

According to a determination result in operation S1520, when it is determined that the user interaction is the head up interaction (S1520: Yes), the ceiling space is displayed as the main space and a service (or information) corresponding thereto is provided (S1530).

According to the determination result in operation S1520, when it is determined that the user interaction is not the head up interaction (S1520: No), it is determined whether or not the received user interaction is a head down interaction (S1540).

According to a determination result in operation S1420, when it is determined that the user interaction is the head down interaction (S1540: Yes), the floor space is displayed as the main space and a service (or information) corresponding thereto is provided (S1550).

In an embodiment, the information service may be provided when the ceiling space is displayed as the main space, the control service may be provided when the floor space is displayed as the main space, and the commerce service may be provided in the wall space. However, exemplary embodiments are not limited thereto.

In another embodiment, a content reproducing screen, such as a video call function, or an image reproducing function, may be displayed in the ceiling space. However, exemplary embodiments are not limited thereto.

In one embodiment, a user interaction for displaying the ceiling space as the main space may be a pointing up motion for pointing to a remote controller upward, and a user interaction for displaying the floor space as the main space may be a pointing down motion for pointing to the remote controller downward.

The stellar GUI according to an exemplary embodiment may be implemented in an application form which is software that may be directly used on an operating system (OS) by the user. Further, the application may be provided in an icon interface form on the screen of the display apparatus 100, but this is not limited thereto.

According to the exemplary embodiments as described above, different information, functions, services may be provided by a simpler user interaction, and therefore, user convenience may be improved.

The above-described control methods of a display apparatus according to the above-described various exemplary embodiments may be implemented with a computer-executable program code, recorded in various non-transitory computer-recordable media, and provided to servers or apparatuses to be executed by a processor.

For example, the non-transitory computer-recordable medium, in which a program for performing a method of generating a UI screen displaying different type of information according to a user interaction type is stored, may be provided.

The non-transitory computer-recordable medium is not a medium configured to temporarily store data such as a register, a cache, or a memory but an apparatus-readable medium configured to semi-permanently store data. Specifically, the above-described applications or programs may be stored and provided in the non-transitory computer-recordable medium such as a compact disc (CD), a digital versatile disc (DVD), a hard disk, a Blu-ray disc, a universal serial bus (USB), a memory card, or a read only memory (ROM).

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display configured to display a graphic user interface (GUI) screen including a plurality of regions;
a user interface configured to receive a user interaction with respect to the GUI screen; and
a controller configured to control the display to display a region corresponding to the user interaction among the plurality of regions as a main region, according to a changed perspective and configured to perform a control operation mapped to the main region.

2. The display apparatus as claimed in claim 1, wherein a plurality of control operations of providing at least one from among information, services, and functions are mapped to the plurality of regions, respectively.

3. The display apparatus as claimed in claim 1, wherein the plurality of regions include a ceiling region located on an upper portion of the GUI screen, a wall region located on an intermediate portion of the GUI screen, and a floor region located on a bottom portion of the GUI screen.

4. The display apparatus as claimed in claim 3, wherein the controller provides an information service when the ceiling region is displayed as the main region.

5. The display apparatus as claimed in claim 4, wherein the information service includes a weather information providing service.

6. The display apparatus as claimed in claim 3, wherein the controller provides a commerce service when the wall region is displayed as the main region.

7. The display apparatus as claimed in claim 6, wherein the commerce service is a service for providing virtual purchase of a product in connection with real purchase of the product.

8. The display apparatus as claimed in claim 3, wherein the controller provides a control service when the floor region is displayed as the main region.

9. The display apparatus as claimed in claim 8, wherein control service includes at least one from among a home device control service and a home security control service.

10. The display apparatus as claimed in claim 3, wherein the user interface receives the user interaction according to a head direction of a user, and the controller controls to display the ceiling region as the main region when a user interaction according to an upward head direction of the user is received, and to display the floor region as the main region when a user interaction according to a downward head direction of the user is received, in a state in which the wall region is displayed as the main region.

11. The display apparatus as claimed in claim 2, wherein the user interface receives a remote controller signal according to a motion of a remote control apparatus configured to remotely control the display apparatus, and
the controller controls to display the ceiling region as the main region when a remote controller signal corresponding to a motion in which the remote control apparatus is moved upward is received, and to display the floor region as the main region when a remote controller signal corresponding to a motion in which the remote control apparatus is moved downward is received, in a state in which the wall region is displayed as the main region.

12. The display apparatus as claimed in claim 1, wherein the controller controls to display a background element based on at least one from among external environment information and a type of content corresponding to the control operation mapped to the main region.

13. A method of providing a graphic user interface (GUI) screen of a display apparatus configured to provide a GUI screen including a plurality of regions, the method comprising:
receiving a user interaction with respect to the GUI screen; and
displaying a region corresponding to the user interaction among the plurality of regions as a main region according to a changed perspective, and performing a control operation mapped to the main region.

14. The method as claimed in claim 13, wherein a plurality of control operations of providing at least one from among information, services, and functions are mapped to the plurality of regions, respectively.

15. The method as claimed in claim 13, wherein the plurality of regions include a ceiling region located on an upper portion of the GUI screen, a wall region located on an intermediate portion of the GUI screen, and a floor region located on a bottom portion of the GUI screen.

16. The method as claimed in claim 15, wherein the performing comprises providing an information service when the ceiling region is displayed as the main region.

17. The method as claimed in claim 15, wherein the performing comprises providing a commerce service when the wall region is displayed as the main region.

18. The method as claimed in claim 15, wherein the performing comprises providing a control service when the floor region is displayed as the main region.

19. The method as claimed in claim 18, wherein the control service comprises at least one from among a home device control service and a home security control service.

20. The method as claimed in claim 15, wherein the displaying comprises displaying the ceiling region as the main region when a user interaction according to an upward head movement is received, and displaying the floor region as the main region when a user interaction according to a downward head movement is received, in a state in which the wall region is displayed as the main region.

21. A display apparatus comprising:
a display configured to display a graphic user interface (GUI) screen comprising a three dimension (3D) space, the 3D space comprising a plurality of plane images;
a user interface configured to receive a user input for selecting at least one of plane images of the GUI screen; and
a controller configured to perform a control operation corresponding to the selected at least one of the plurality of plane images.

22. The display apparatus as claimed in claim 21, wherein the user input indicates a viewpoint position of a user in the 3D space and the controller controls the display to display the GUI screen rearranged according to the viewpoint position indicated by the user input.

23. The display apparatus as claimed in claim 22, wherein the controller determines the at least one of the plurality of plane images based on a plane image of which display area has a predetermined ratio of the rearranged GUI screen.

24. The display apparatus as claimed in claim 22, wherein the controller controls to generate the rearranged GUI screen by rotating the 3D space of the GUI screen according to the viewpoint position indicated by the user input.

25. The display apparatus as claimed in claim 22, wherein the controller controls to generate the rearranged GUI screen by replacing the at least one of the plane images of the GUI screen with a new plane image.

26. The display apparatus as claimed in claim 21, wherein a plurality of control operations are mapped to the plurality of plane images, respectively.

27. The display apparatus as claimed in claim 26, wherein the GUI screen comprises a plurality of 3D spaces, the plurality of 3D spaces corresponding to a plurality of different categories of functions provided by the display apparatus, respectively, and
wherein the user interface receives a user input for selecting at least one of the plurality of 3D spaces.

28. The display apparatus as claimed in claim 27, wherein the plurality of control operations mapped to the plurality of plane images of the same 3D space correspond to the same category of a function.

29. The display apparatus as claimed in claim 21, wherein the user interface receives the user input through a remote controller comprising at least one from among a motion sensor, a touch sensor, or an optical joystick (OJ) sensor, a physical button, a display screen, and a microphone.

30. The display apparatus as claimed in claim 29, wherein when the user interface receives the user input through the remote controller comprising the motion sensor, the user input is generated based on a motion of a user detected by the motion sensor.

31. The display apparatus as claimed in claim 1, wherein the main region is a region that occupies the GUI screen at a predetermined ratio or more.

32. A user interface processing device comprising:
at least one processor operable to read and operate according to instructions within a computer program; and
at least one memory operable to store at least portions of said computer program for access by said processor;
wherein said computer program includes algorithms to cause said processor to implement:
a user interface configured to receive a user input indicating a viewpoint of a user with respect to a graphic user interface (GUI) screen comprising a three dimension (3D) space; and
a controller configured to perform a control operation corresponding to the GUI screen adjusted according to the viewpoint of the user based on the user input, the control operation being selected from a plurality of control operations mapped to objects displayed in the adjusted GUI screen.

33. A non-transitory computer readable storing medium that stores a program for enabling a computer to perform the method of claim 13.
